(19) United States
(12) Patent Application Publication
(10) Pub. No.: US 2023/0195280 A1
(43) Pub. Date: Jun. 22, 2023

(54) IDENTIFICATION DEVICE, IDENTIFICATION METHOD, AND IDENTIFICATION PROGRAM

(71) Applicant: Nippon Telegraph and Telephone Corporation, Tokyo (JP)

(72) Inventors: Shiro OGASAWARA, Musashino-shi, Tokyo (JP); Takeshi MASUDA, Musashino-shi, Tokyo (JP); Fumihiro YOKOSE, Musashino-shi, Tokyo (JP); Hidetaka KOYA, Musashino-shi, Tokyo (JP); Yuki URABE, Musashino-shi, Tokyo (JP)

(21) Appl. No.: 17/926,170

(22) PCT Filed: May 29, 2020
(86) PCT No.: PCT/JP2020/021497

§ 371 Date: Nov. 18, 2022

(51) Int. Cl. G06F 3/0482; G06F 9/451

(52) U.S. Cl. CPC G06F 3/0482; G06F 9/451

(57) ABSTRACT

An identification apparatus (10) includes a screen configuration comparison unit (1314) configured to determine equivalence of screen components between sample screen data and processing target screen data based on whether a screen component in a screen structure of the sample screen data and a screen component in a screen structure of the processing target screen data have similar relationships to other screen components in the respective screen structures.

### TECHNICAL FIELD

The present invention relates to an identification apparatus, an identification method, and an identification program.

### BACKGROUND ART

As an identification method of screen components such as text boxes, list boxes, buttons, labels, and the like that make up the screen of a program that runs in a terminal, a method of identifying, in a program in which the screen is written in HyperText Markup Language (HTML), the screen components by tags corresponding to the types of the screen components of a control target or HTML attributes thereof has been proposed (see, for example, PTL 1). The method described in PTL 1 utilizes that there are attributes whose values do not change (hereinafter referred to as “invariant attributes”) if they are equivalent screen components in equivalent screens regardless of time when screen data is acquired or the terminal, and screen components in a screen can be uniquely specified by invariant attributes or a combination thereof.

An identification method for general programs including those whose screens are not written in HTML has also been proposed (see, for example, PTL 2). In the method described in PTL 2, arrangement patterns representing conditions of relative arrangement relationships between screen components on a sample screen (two-dimensional plane) are prepared as determination conditions of equivalence of the screen components of a control target, and screen components are identified by searching for screen components that satisfy the arrangement patterns on a processing target screen.

### CITATION LIST

### Patent Literature

PTL 1: JP 2017-072872 A

PTL 2: JP 2018-077763 A

### SUMMARY OF THE INVENTION

### Technical Problem

In general programs including those whose screens are not written in HTML, there are cases where there are few invariant attributes, and the invariant attributes are only the types of the screen components even if information of the screen components can be acquired. For this reason, it may not be possible to uniquely identify each screen component in the screen by using attributes or a combination of a plurality of attributes.

For example, in a screen written in HTML, each screen component may be uniquely identified in the screen by tags, id attributes, name attributes, or a combination thereof for the text boxes, list boxes, buttons, or the like in the input form. However, there is no such attribute in the attributes of screen components that can be acquired by Microsoft Active Accessibility (MSAA) or UI Automation (UIA). Even if there is “ID” or an attribute of a similar name, the value is valid only on that terminal and at that time, and the value will be a different value when an equivalent screen component is displayed on another terminal and at another time, so that the attribute cannot be used for unique identification. In such a screen, the screen and the screen components cannot be identified by the method described in PTL 1.

Meanwhile, although the method described in PTL 2 targets general programs, the relative arrangement relationships of screen components on a screen (two-dimensional plane) may change depending on the size of the screen or the amount of display contents.

FIG. 46 is a diagram illustrating an example of a screen. For example, the text box for entering the street address, and the like and the “register” button, which are placed adjacent to the left and right (or up and down) on the right side in the screen Pa of (1) of FIG. 46, are placed diagonally to the lower left as illustrated in the screen Pb of (2) of FIG. 46 when the width of the screen is reduced. For such a program, the screen and the screen components cannot be identified by the method described in PTL 2.

No method has been proposed for automatically creating arrangement patterns used in identification of the processing target screen from the relative arrangement relationships between the screen components specified at the time of operation setting on the sample screen (two-dimensional plane), in particular, method for determining how far the relative arrangement relationships on the sample screen should be reproduced on the processing target screen and reflected in the conditions of the relative arrangement relationships. For this reason, it is necessary for a person to create arrangement patterns used in identification of the processing target screen while assuming variations that may occur on the processing target screen for each screen or screen component, which causes a problem that the burden on the creator is heavy.

The present invention has been made in view of the above, and an object of the present invention is to provide an identification apparatus, an identification method, and an identification program capable of specifying screen components without being affected by variations in screen structure or changes in arrangement.

### Means for Solving the Problem

In order to solve the above-described problems and achieve the object, an identification apparatus according to the present invention includes a screen configuration comparison unit configured to determine equivalence of screen components between sample screen data and processing target screen data based on whether a screen component in a screen structure of the sample screen data and a screen component in a screen structure of the processing target screen data have similar relationships to other screen components in each of the screen structure of the sample screen data and the screen structure of the processing target screen data.

An identification method according to the present invention is an identification method performed by an identification apparatus and includes determining equivalence of screen components between sample screen data and processing target screen data based on whether a screen component in a screen structure of the sample screen data and a screen component in a screen structure of the processing target screen data have similar relationships to other screen components in each of the screen structure of the sample screen data and the screen structure of the processing target screen data.

An identification program according to the present invention causes a computer to perform determining equivalence of screen components between sample screen data and processing target screen data based on whether a screen component in a screen structure of the sample screen data and a screen component in a screen structure of the processing target screen data have similar relationships to other screen components in each of the screen structure of the sample screen data and the screen structure of the processing target screen data.

### Effects of the Invention

According to the present invention, screen components can be specified without being affected by variations in screen structure or changes in arrangement.

### BRIEF DESCRIPTION OF DRAWINGS

FIG. 1 is a diagram illustrating an example of screen data.

FIG. 2 is a diagram related to identification of screen components.

FIG. 3 is a diagram for explaining determination of equivalence according to an embodiment.

FIG. 4 is a diagram for explaining trimming of a screen structure of a sample according to the embodiment.

FIG. 5 is a diagram for explaining an example of a configuration of an identification system according to the embodiment.

FIG. 6 is a diagram illustrating an example of a data configuration of data stored in a processing target screen data storage unit.

FIG. 7 is a diagram illustrating an example of a data configuration of data stored in an identification result storage unit.

FIG. 8 is a diagram illustrating an example of a data structure of data stored in an identification information storage unit.

FIG. 9 is a diagram illustrating an example of a data configuration of data stored in a screen attribute comparison rule storage unit.

FIG. 10 is a diagram illustrating an example of a data configuration of data stored in an element attribute comparison rule storage unit.

FIG. 11 is a diagram illustrating an example of a data configuration of data stored in an identification case storage unit.

FIG. 12 is a flowchart illustrating a processing procedure of processing in an identification apparatus illustrated in FIG. 5.

FIG. 13 is a flowchart illustrating a processing procedure of an identification process illustrated in FIG. 12.

FIG. 14 is a flowchart illustrating a processing procedure of a screen structure comparison process illustrated in FIG. 13.

FIG. 15 is a flowchart illustrating a processing procedure of a process for evaluating an association method in an association method derivation process.

FIG. 16 is a flowchart illustrating a processing procedure of a screen structure equivalence determination process illustrated in FIG. 14.

FIG. 17 is a diagram for explaining enumeration of repeating units in a case where the repeating structure has one layer.

FIG. 18 is a diagram for explaining enumeration of repeating units in a case where the repeating structure has one layer.

FIG. 19 is a diagram for explaining computation results acquired by a screen configuration comparison unit.

FIG. 20 is a diagram for explaining enumeration of repeating units in a case where the repeating structure has a plurality of layers.

FIG. 21 is a diagram for explaining enumeration of repeating units in a case where the repeating structure has a plurality of layers.

FIG. 22 is a diagram for explaining enumeration of repeating units in a case where the repeating structure has a plurality of layers.

FIG. 23 is a diagram for explaining enumeration of repeating units in a case where the repeating structure has a plurality of layers.

FIG. 24 is a diagram for explaining enumeration of repeating units in a case where the repeating structure has a plurality of layers.

FIG. 25 is a diagram for explaining enumeration of repeating units in a case where the repeating structure has a plurality of layers.

FIG. 26 is a diagram for explaining computation results acquired by the screen configuration comparison unit.

FIG. 27 is a diagram for explaining computation results acquired by the screen configuration comparison unit.

FIG. 28 is a flowchart illustrating a processing procedure of a pre-trimming process.

FIG. 29 is a flowchart illustrating a processing procedure of a trimming target specifying process illustrated in FIG. 28.

FIG. 30 is a flowchart illustrating a processing procedure of a screen component enumeration process of ancestors/neighbors illustrated in FIG. 29.

FIG. 31 is a flowchart illustrating a processing procedure of a post-identification trimming process illustrated in FIG. 12.

FIG. 32 is a diagram for explaining a process for obtaining control target identification assisting screen components.

FIG. 33 is a diagram illustrating a process example for obtaining a similar screen configuration.

FIG. 34 is a diagram illustrating an example of a process for obtaining control target identification assisting screen components.

FIG. 35 is a diagram illustrating an example of a process for obtaining control target identification assisting screen components.

FIG. 36 is a diagram illustrating an example of a process for obtaining control target identification assisting screen components.

FIG. 37 is a diagram illustrating an example of a process for obtaining control target identification assisting screen components.

FIG. 38 is a diagram illustrating an example of a process for obtaining control target identification assisting screen components.

FIG. 39 is a diagram for explaining a process for obtaining control target identification assisting screen components in a case where the repeating structure has one layer.

FIG. 40 is a diagram for explaining a process for obtaining control target identification assisting screen components in a case where the repeating structure has one layer.

FIG. 41 is a diagram for explaining a process for obtaining control target identification assisting screen components in a case where the repeating structure has one layer.

FIG. 42 is a diagram for explaining a process for obtaining control target identification assisting screen components in a case where an arbitrary number of repeating structures with an arbitrary number of layers nested are included.

FIG. 43 is a diagram schematically illustrating common portions and non-common portions to an equivalent or non-equivalent screen structure.

FIG. 44 is a diagram illustrating an example in which equivalence of screen structures changes due to the number of equivalent partial structures.

FIG. 45 is a diagram illustrating an example of a computer that executes a program to implement an identification apparatus and an assistance apparatus.

FIG. 46 is a diagram illustrating an example of a screen.

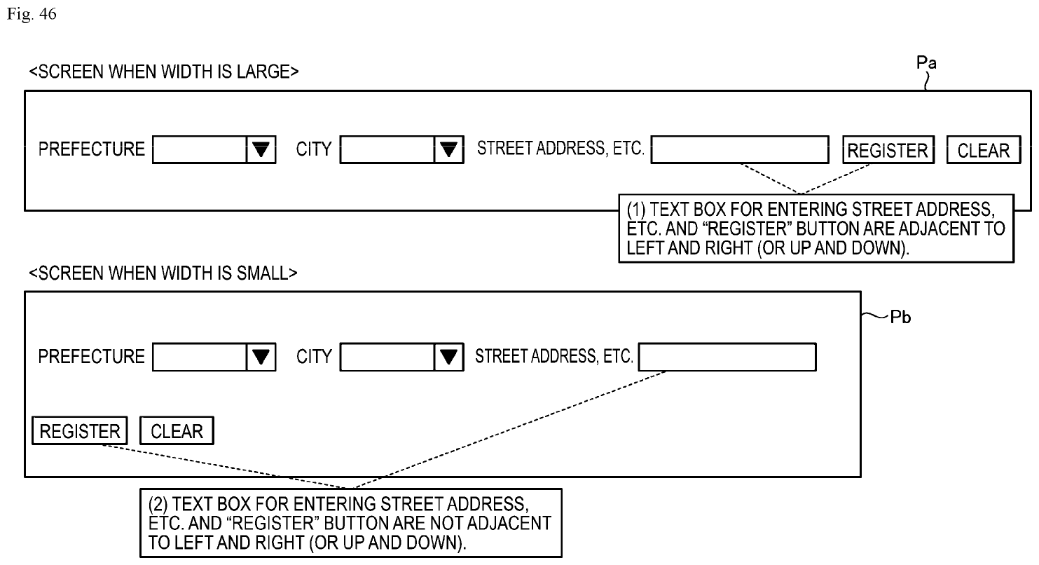

### DESCRIPTION OF EMBODIMENTS

Hereinafter, an embodiment of the present invention will be described in detail with reference to the drawings. Note that the present invention is not limited to the embodiment. In description of the drawings, the same portions are denoted by the same reference signs.

Hereinafter, in a case where “\hat{ }A” is written for A, \hat{ }A is equivalent to a “symbol in which “\hat{ }” is written immediately above “A””. In a case where “˜A” is written for A, ˜A is equivalent to a “symbol in which “˜” is written immediately above “A””. In a case where “⁻A” is written for A, ⁻A is equivalent to a “symbol in which “⁻” is written immediately above “A””. In a case where “(option)” is written, it means that the component or the process can be omitted. A number is inserted after “option” to distinguish each option.

### Embodiment

### 1.1. Screen Data

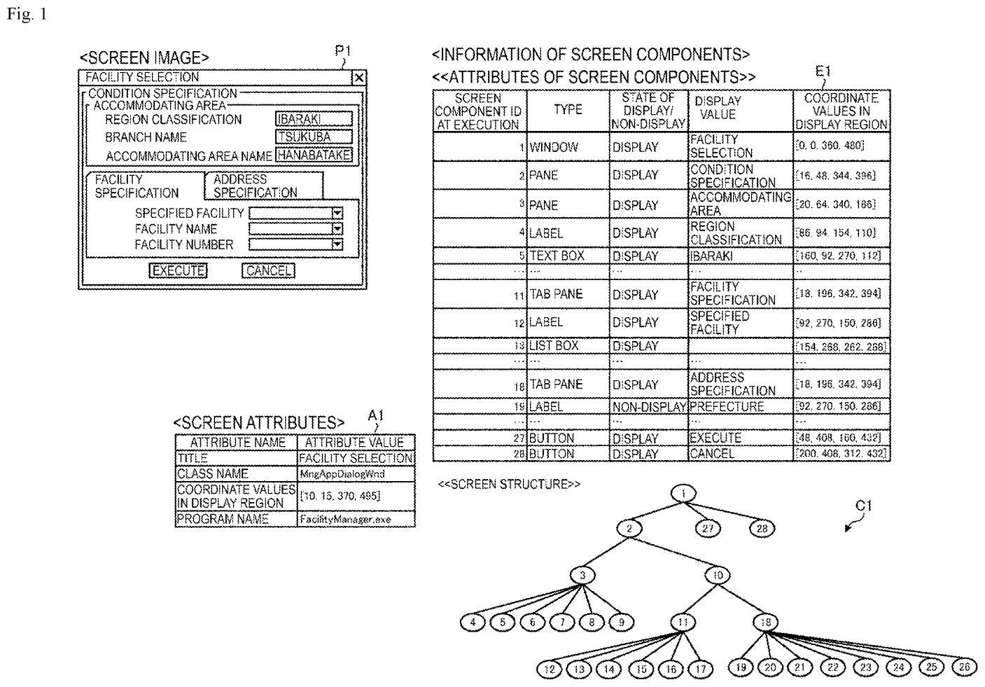

An identification method according to the embodiment is a method for identifying a screen and components of the screen. Thus, screen data of a program will be described. FIG. 1 is a diagram illustrating an example of the screen data.

In terminal operations, the operator refers to the values displayed in the text boxes, list boxes, buttons, labels, or the like (hereinafter referred to as “screen components”) that make up the screen of the program running in the terminal, and performs operations such as inputting or selecting values for screen components. For this reason, in some programs for the purpose of automation or assistance of terminal operations or grasping and analyzing the operation performance, the image P1 of the screen, the attributes A1 of the screen, and the information of the screen components illustrated in FIG. 1, or part of them are acquired and used. Note that the image P1 of the screen, the attributes A1 of the screen, and the information of the screen components are collectively referred to as “screen data”. The attributes A1 of the screen include the title, the class name, the coordinate values of the display region, the name of the program being displayed, and the like.

The information of the screen components can be acquired by UIA, MSAA, or an interface independently provided by the program. The information of the screen components includes not only information that can be used independently for each screen component (hereinafter referred to as “attribute”), such as the type of screen component, the state of display or non-display, the display value, and the coordinate values of the display region, but also information (hereinafter referred to as “screen structure”) that is internally held by the program and represents relationships such as inclusion relationships or ownership relationships between screen components. FIG. 1 exemplifies the attributes E1 of the screen components and exemplifies the screen structure C1.

On screens displayed at different times and on different terminals, even if the functions provided to operators are the same (hereinafter referred to as “equivalent”), the values of some attributes of the screen components differ depending on the displayed matter or the implementation status of the operation. On screens displayed at different times and on different terminals, even if the functions provided to operators are equivalent, the presence or absence of screen components themselves is also different. For example, if the number of items included in the matter is different, the number of rows in the table displaying them will change. Alternatively, the display or non-display of an error message may change depending on the implementation status of the operation. For this reason, the screen structure also varies.

1.2. Identification of Screen and Screen Components

In a program for the purpose of automation, assistance, or the like of terminal operations, screen data to be sampled on a specific terminal is acquired at the time of operation setting, and the screen components that are targeted for acquisition or operation of the display values (hereinafter referred to as “control target”) are specified by using the screen data. When performing processing of automation or assistance, screen data (hereinafter referred to as “processing target screen data”) is acquired at the time of execution from the screen displayed on any terminal including those other than the specific terminal for which operation setting has been performed, and is collated with determination conditions of equivalence of the sample screen data, or the screen or the screen components obtained by processing the sample screen data. As a result, from among the screen data at that time, the screen components equivalent to the screen components of the control target in the sample screen data are specified, and targeted for acquisition or operation of the display values.

In a program for the purpose of grasping and analyzing the actual business situation, information related to the screen data and the operations are acquired and collected as an operation log at the timing when the operator performs an operation on the screen components on each terminal. In order to enable people to grasp and analyze patterns or trends for a large amount of collected operation logs, screen data acquired at different times and on different terminals are classified such that screen data with equivalent screens or screen components of the operation target are in the same group, and are used for deriving the screen operation flow, aggregating the numbers of operations performed or the operation times, and the like. As a method for performing this classification, a method is conceivable in which some screen data are sampled from a large amount of operation logs as sample screen data, and the remaining screen data of the operation logs are collated with the sample screen data to determine the classification destination.

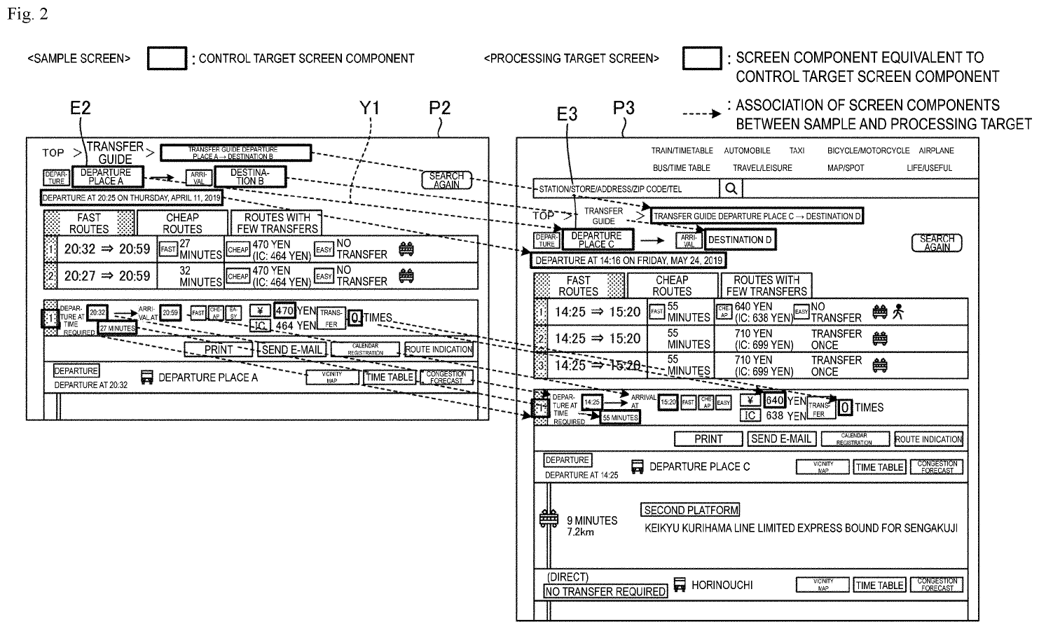

Hereinafter, determining whether the screens and the screen components are equivalent to provide the same functions to the operator for sample screen data and processing target screen data which are acquired at different times and on different terminals, and specifying screen components equivalent to the screen components of the sample screen data from among the screen components of the processing target screen data is described as “identification”. FIG. 2 is a diagram related to identification of screen components. The identification is, for example, to specify that the screen component E3 of the processing target screen data P3 in FIG. 2 is equivalent to the screen component E2 of the sample screen data P2 (see arrow Y1 in FIG. 2). Note that the processing target screen data may be acquired from the screen displayed at the time when the identification process according to the present embodiment is performed, or may be separately acquired and accumulated.

The identification of a screen based on the attributes of the screen and the identification of screen components based on information of the screen components have a complementary relationship to each other. For example, screen components included in screens may be completely different even if the screen titles are the same. Thus, it cannot be determined whether the screens are equivalent only by comparing the attributes of the screens. Thus, in the identification of the screen components, by investigating whether screen components equivalent to the screen components of the control target in the sample screen data are included in the processing target screen data, and taking the investigation results into consideration, it can be confirmed whether the screen data are equivalent. On the contrary, if the titles of the screens are different, it can be confirmed that the screens are not equivalent without identifying a plurality of screen components, which helps to reduce the amount of calculation.

Hereinafter, as the identification method according to the embodiment, a method for identifying screen components will be mainly described. However, the method is actually related to the identification of the screen.

### 2. Overview of Identification Method According to the Embodiment

Next, the embodiment will be described. With the conventional techniques, it is difficult to identify the screen and the components of the screen under the following first to fourth conditions. In the present embodiment, it is possible to cope with a wide range of conditions including such severe conditions.

The first condition is a case in which the attribute values of the screen components and the screen structure vary depending on the displayed matter or the implementation status of the operation even with the equivalent screen. The second condition is a case in which the invariant attributes are limited to the types of the screen components or the like in the information of the screen components that can be acquired, and each screen component in the screen cannot be uniquely identified even by using the attributes of the screen components of the control target or the ancestors thereof, or combinations of a plurality of attributes. The third condition is a case in which the arrangement of the screen components on the two-dimensional plane changes depending on the size of the screen or the amount of display contents of each screen component. The fourth condition is that it is not always necessary for a person to create the determination conditions of the equivalence of the screen components of the control target for each screen or screen component.

In the identification method according to the embodiment, it is determined whether a screen component (hereinafter referred to as a “screen component of the sample”) in the screen structure (hereinafter referred to as the “screen structure of the sample”) of the sample screen data and a screen component (hereinafter referred to as a “screen component of the processing target”) in the screen structure (hereinafter referred to as the “screen structure of the processing target”) of the processing target screen data that have the same attribute values and can be equivalent have similar relationships to other screen components in the respective screen structures, and the equivalence of the screens and the screen components is determined.

In the identification method according to the embodiment, for example, in a case where the screen structure is a directed tree, it is determined whether screen components that have the same attribute values and can be equivalent have the same relationships, for not only screen components of the control target or the ancestors thereof, but also screen components that have sibling relationships, as well as screen components that are not in ancestor-descendant relationships and have different depths from the root screen components.

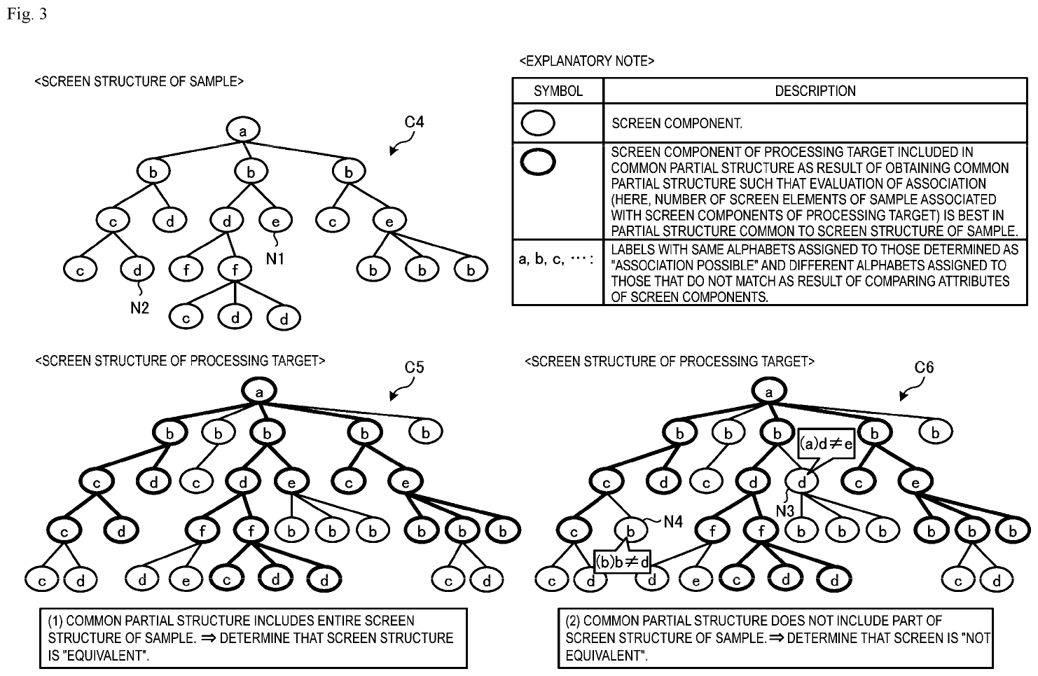

FIG. 3 is a diagram for explaining determination of equivalence according to the embodiment. Specifically, in the identification method according to the embodiment, as illustrated in FIG. 3, the image structure C4 of the sample and the screen structures C5 and C6 of the processing target are compared, and common partial structures are obtained such that the evaluation of the association method is best based on the number of screen components associated with the screen components of the processing target among all of the screen components of the sample, and the like. The screen components included in the common partial structures are screen components of the sample that are associated with screen components of the processing target, or screen components of the processing target that are associated with screen components of the sample. In the identification method according to the embodiment, the equivalence of the screen and the screen components is determined by comparing the ratio of screen components associated with the screen components of the processing target among all of the screen components of the sample, or the like, with a predetermined threshold value.

In the identification method according to the embodiment, it is determined that the screen structure C5 of the processing target is equivalent to the screen structure C4 of the sample because the common partial structure includes the entire screen structure C4 of the sample (see (1) in FIG. 3). On the other hand, the nodes N3 and N4 of the screen structure C6 of the processing target are different from the nodes N1 and N2 of the screen structure C4 of the sample (see (a) and (b) of (2) in FIG. 3). For this reason, in the identification method according to the embodiment, it is determined that the screen structure C5 of the processing target is not equivalent to the screen structure C4 of the sample because the common partial structure does not include a part of the screen structure C4 of the sample (see (2) in FIG. 3).

In the identification method according to the present embodiment, it is sufficient that at least the types of the screen components can be used as the attribute values of the screen components in practical use, so that the identification method is not affected by the variations of other attribute values. In the identification method according to the present embodiment, variations in screen structure can be tolerated because determination is made not by whether the screen structures match perfectly, but by obtaining a common partial structure for which the evaluation of the association method is best, and comparing the ratio of the elements of the common partial structure with a predetermined threshold value.

In the identification method according to the present embodiment, even in a case where the invariant attributes are limited to the types of the screen components and the like, and each screen component in the screen cannot be uniquely identified even by using the attributes of the screen components of the control target or the ancestors thereof, or combinations of a plurality of attributes, whether screen components having the same attribute values have the same relationships is considered more broadly even for screen components that are not in ancestor-descendant relationships, so that identification can be made in more cases.

Further, the screen structure does not change depending on the size of the screen or the amount of display contents of each screen component. For this reason, even if the arrangement of the screen components on the two-dimensional plane changes, the identification method according to the present embodiment can determine the equivalence of the screen components without being affected by the changes.

In the identification method according to the present embodiment, in the operation setting before performing the identification process, it is sufficient that at least screen data to be sampled is acquired by a program for the purpose of automation or assistance of the terminal operations, so that it is not always necessary for a person to create the determination conditions of the equivalence of the screen components of the control target.

The amount of calculation required to identify the screen and the screen components increases as the number of screen components in the screen structure of the sample increases. Thus, in the identification method according to the present embodiment, the control target screen components required by programs or the like for the purpose of automation or assistance of the terminal operations and the screen components that affect the identification are left, and the others are trimmed.

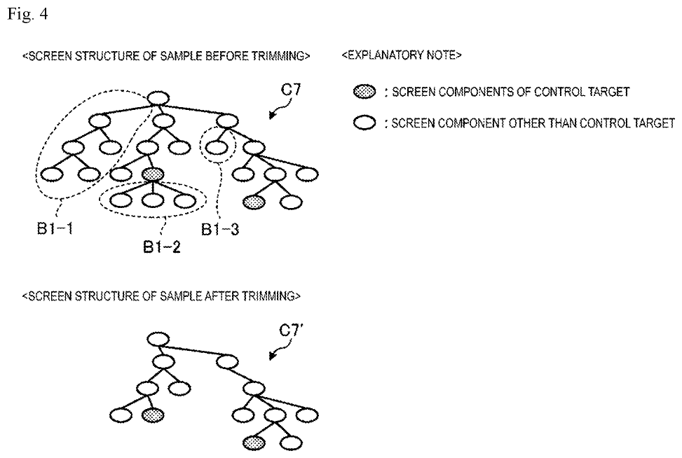

FIG. 4 is a diagram for explaining trimming of a screen structure of a sample according to the embodiment. As illustrated in FIG. 4, in the identification method according to the embodiment, the screen structure of the sample is trimmed such that the control target screen components and the ancestors and the neighbors thereof remain. For example, in the identification method according to the embodiment, in the screen structure C7 of the sample, the portions B1-1 to B1-3 including screen components other than the control target are trimmed to generate the screen structure C7′ of the sample.

Alternatively, in the identification method according to the embodiment, the control target screen components are compared with the ancestors, the descendants, or the neighbors of each of screen components similar to the control target screen components in the screen structure of the sample, and common portions and non-common portions are obtained. In addition, in the identification method according to the embodiment, common portions and non-common portions are obtained by comparison with the screen structures of equivalent or non-equivalent screen data accumulated in the identification case storage unit. As a result, in the identification method according to the present embodiment, portions that do not affect the identification results are specified, and trimming is performed.

As described above, in the identification method according to the embodiment, the control target screen components required by programs or the like for the purpose of automation or assistance of the terminal operations and the screen components that affect the identification are left, and the others are trimmed, so that the number of screen components in the screen structure of the sample is reduced, and the amount of calculation required for identification is reduced.

### 3. Identification System According to the Embodiment

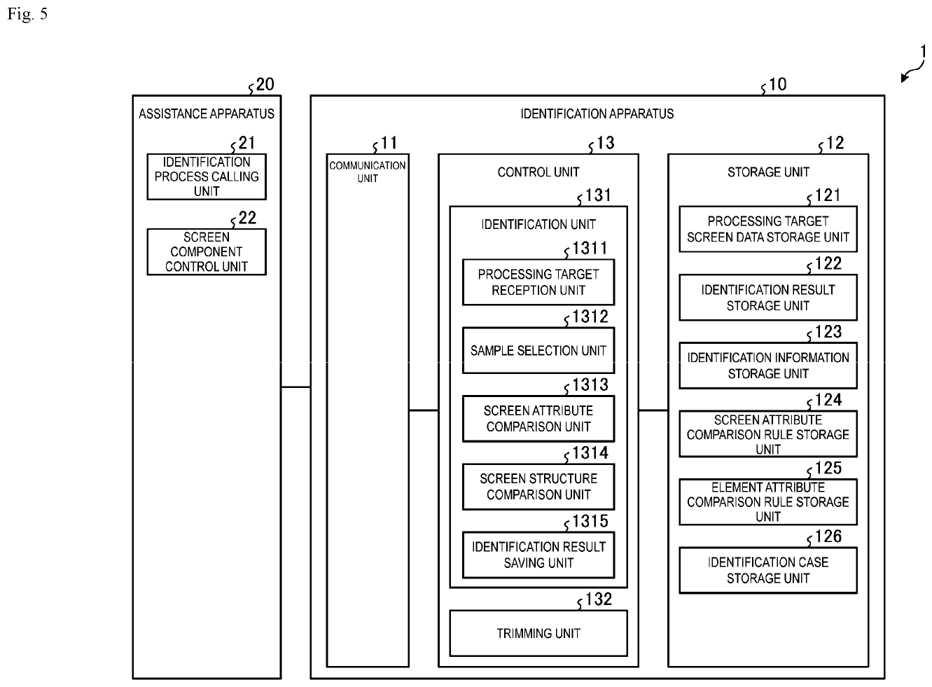

Next, an identification system according to the embodiment will be described. FIG. 5 is a diagram for explaining an example of the configuration of the identification system according to the embodiment.

The identification system 1 according to the present embodiment includes an identification apparatus 10 and an assistance apparatus 20. The identification apparatus 10 identifies the equivalence between sample screen data and processing target screen data based on whether a screen component in the screen structure of the sample and a screen component in the screen structure of the processing target have similar relationships to other screen components in the respective screen structures. The assistance apparatus 20 performs automation, assistance, and the like of the terminal operations. The identification apparatus 10 performs communication with the assistance apparatus 20. Note that, in the example illustrated in FIG. 5, the identification apparatus 10 is described as another apparatus operating in cooperation with the assistance apparatus 20, but may operate as a partial functional unit inside of the assistance apparatus 20.

### 4. Assistance Apparatus

The assistance apparatus 20 will be described. The assistance apparatus 20 is, for example, implemented by a computer including a Read Only Memory (ROM), a Random Access Memory (RAM), a Central Processing Unit (CPU), and the like reading a predetermined program and by the CPU executing the predetermined program. As illustrated in FIG. 5, the assistance apparatus 20 includes an identification process calling unit 21 and a screen component control unit 22.

The identification process calling unit 21 outputs processing target screen data to the identification apparatus 10, and causes the identification apparatus 10 to perform the identification process for the processing target screen data.

The screen component control unit 22 performs control of acquisition or operation of the display value for the screen component of the control target specified at the time of operation setting in advance by using sample screen data, based on the result of the identification process performed by the identification apparatus 10.

### 5. Identification Apparatus

The identification apparatus 10 will be described. As illustrated in FIG. 5, the identification apparatus 10 includes a communication unit 11, a storage unit 12, and a control unit 13.

The communication unit 11 is a communication interface for transmitting and/or receiving various data to and/or from another apparatus operating on a common basic apparatus or another apparatus connected via a network or the like. The communication unit 11 is implemented by an API, a Network Interface Card (NIC), or the like, and performs communication between the control unit 13 (described below) and another apparatus via a common basic apparatus or another apparatus via an electrical communication line such as a Local Area Network (LAN) or the Internet.

The storage unit 12 is implemented by a semiconductor memory element such as a Random Access Memory (RAM) or a flash memory, or a storage apparatus such as a hard disk or an optical disk, and stores a processing program for causing the identification apparatus 10 to operate, data used during execution of the processing program, and the like. The storage unit 12 includes a processing target screen data storage unit 121, an identification result storage unit 122, an identification information storage unit 123, a screen attribute comparison rule storage unit 124 (option 2-1), an element attribute comparison rule storage unit 125 (option 3), and an identification case storage unit 126 (option 1-2).

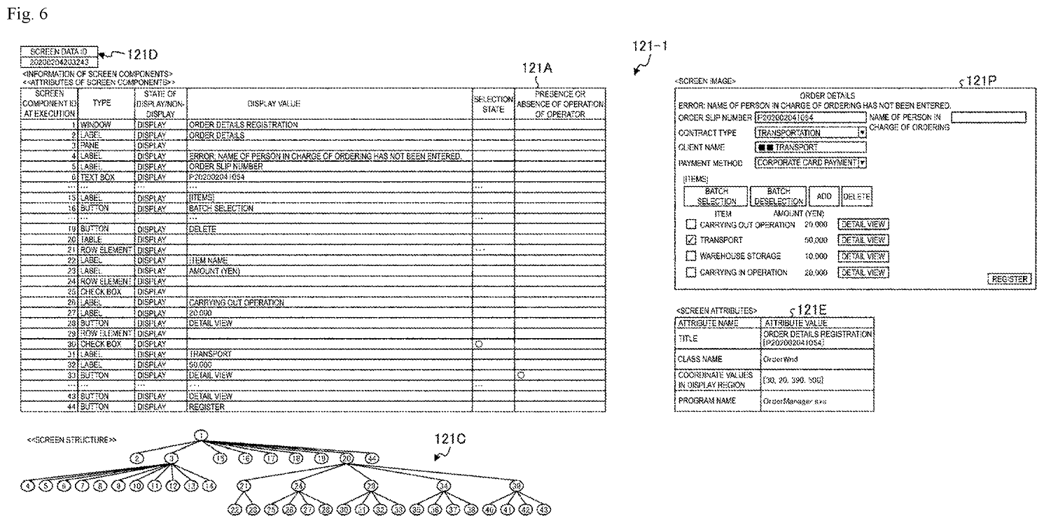

The processing target screen data storage unit 121 stores data related to processing target screen data. FIG. 6 is a diagram illustrating an example of a data configuration of data stored in the processing target screen data storage unit 121. The processing target screen data storage unit 121 stores screen data for each screen of processing target. For example, the processing target screen data storage unit 121 has a data configuration exemplified in the processing target screen data 121-1 in FIG. 6 as screen data of processing target.

The processing target screen data 121-1 includes the screen data ID 121D for the screen data of the processing target, the information of the screen components including the attributes 121A of the screen components and the screen structure 121C, the image data 121P of the screen, and the attribute data 121E of the screen.

The screen data ID 121D includes the ID number which is the identification information of the processing target screen data. The attributes 121A of the screen components include not only the type of the screen components, the state of display or non-display, and the display value included in the attributes E1 of the screen components illustrated in FIG. 1, but also the items of the selection state and the presence or absence of the operation of the operator (at the time of application of option 4-2). The items included in the attributes 121A of the screen components may be similar items to the attributes E1 of the screen components illustrated in FIG. 1. The screen structure 121C indicates relationships such as inclusion relationships and ownership relationships between screen components by representing the screen structure with a directed tree. Similar to the attributes A1 of the screen illustrated in FIG. 1, the attribute data 121E of the screen include items such as the title of the attribute, the class name, the coordinate values of the display region, the name of the program being displayed, and the like.

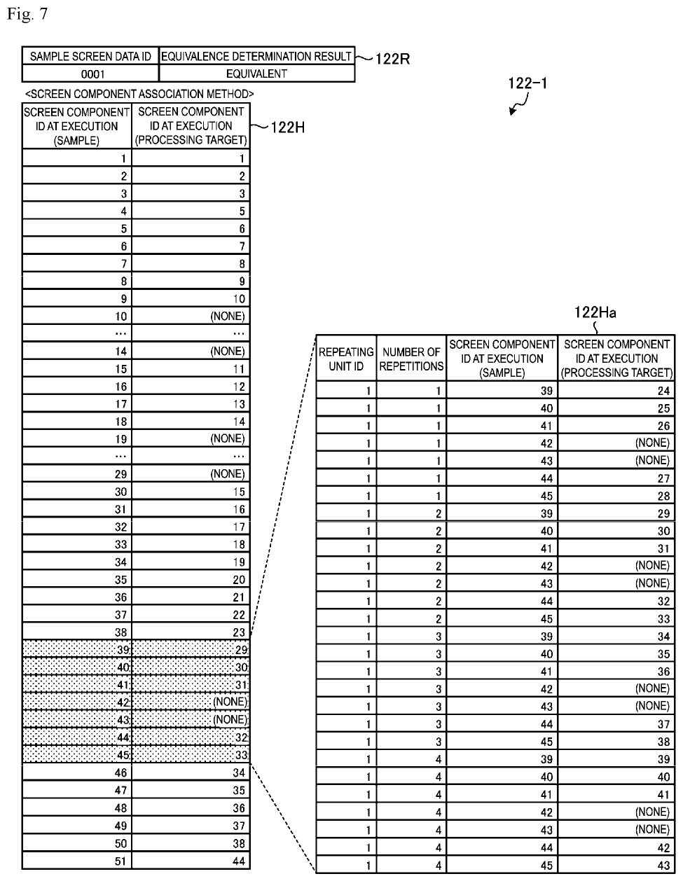

The identification result storage unit 122 stores identification results by the identification unit 131 (described later). FIG. 7 is a diagram illustrating an example of a data configuration of data stored in the identification result storage unit 122. The identification result storage unit 122 stores identification results of the identification processes performed on screen data of processing target. For example, the identification result storage unit 122 includes the data configuration exemplified in the identification result data 122-1 in FIG. 7 as the identification results.

The identification result data 122-1 includes determination data 122R which indicates the ID number of the sample screen data for which the equivalence determination with the screen data of the processing target has been performed, and the determination results thereof, and association data 122H of the screen components between the sample screen data and the processing target screen data. In the association data 122H, in a case where association is performed for a screen structure (repeating structure) in which the same partial structure (repeating unit) appears repeatedly in the identification process, the ID number of the repeating unit (repeating unit ID) and the number of repetitions are added (at the time of application of option 5) as indicated by the association data 122Ha.

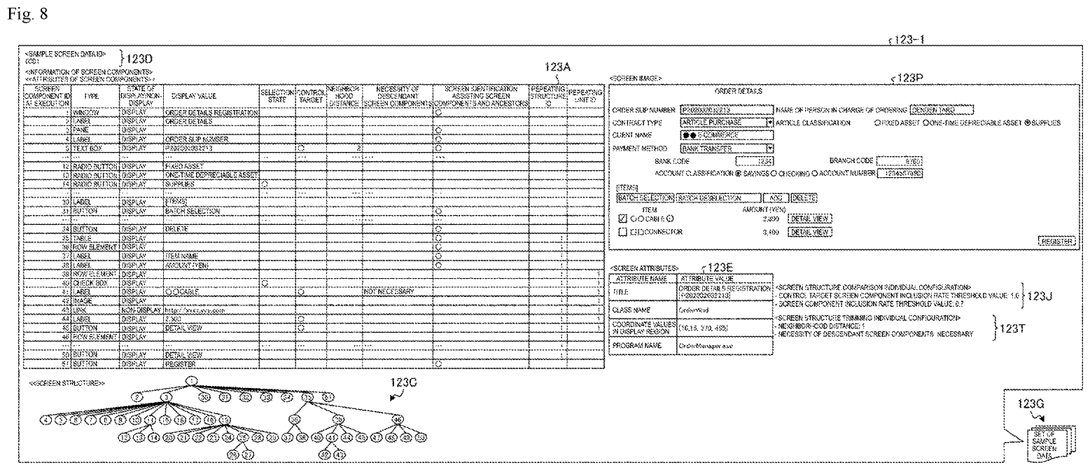

The identification information storage unit 123 stores information related to sample screen data. FIG. 8 is a diagram illustrating an example of a data structure of data stored in the identification information storage unit 123. The identification information storage unit 123 stores screen data for each sample screen data. For example, the identification information storage unit 123 includes a set 123G of sample screen data 123-1 of FIG. 8.

The sample screen data 123-1 includes the sample screen data ID 123D which is the identification information of the sample screen data, the information of the screen components including the attributes 123A of the screen components and the screen structure 123C, the image data 123P of the screen, the attribute data 123E of the screen, the screen structure comparison individual configuration 123J (at the time of application of option 6), and the screen structure trimming individual configuration 123T (at the time of application of option 1-1-1).

As compared with the attributes E1 of the screen components, the attributes 123A of the screen components further include items indicating whether the screen component is the control target, the neighborhood distance (at the time of application of option 1-1-1), the necessity of the descendant screen components (at the time of application of option 1-1-1), the screen identification assisting screen components and the ancestors (at the time of application of option 1-2), the repeating structure ID (at the time of application of option 5), and the repeating unit ID (at the time of application of option 5). The column of the screen identification assisting screen components and the ancestors is an item related to the process of specifying portions that do not affect the identification results to perform trimming. Note that the data illustrated in the column of the screen identification assisting screen components and the ancestors is assumed after trimming by the trimming unit 132, but the screen structure exemplified in FIG. 8 is the one before trimming. The necessity of the descendant screen components is an item related to the process of trimming the screen structure such that the screen components of the control target, and the ancestors and the neighbors thereof remain. The repeating structure ID and the repeating unit ID are items related to the process of specifying all of the equivalents to each screen component of the control target from among each repeating structure in the screen structure of the processing target.

The screen structure comparison individual configuration 123J is a threshold value used in determining whether the sample screen structure and the processing target screen structure are equivalent. The screen structure trimming individual configuration 123T is a set value used for the neighborhood distance and the necessity of the descendant screen components for trimming the screen structure such that the screen components of the control target and the ancestors and the neighbors thereof remain.

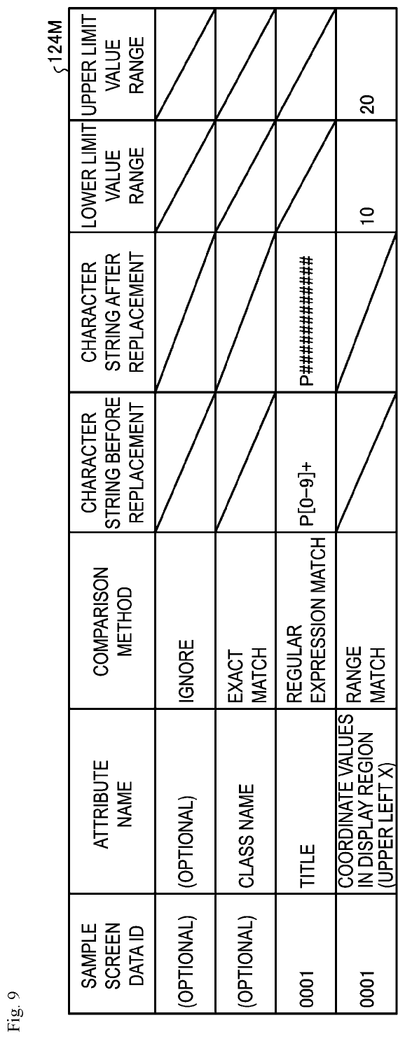

The screen attribute comparison rule storage unit 124 stores various comparison rules applied in a case of comparing the attributes of the screen. FIG. 9 is a diagram illustrating an example of a data configuration of data stored in the screen attribute comparison rule storage unit 124. The screen attribute comparison rule storage unit 124 stores the screen attribute comparison rule 124M including the items of the sample screen data ID, the attribute name, the comparison method, the character string before replacement, the character string after replacement, the lower limit value range, and the upper limit value range. Note that the numerical values of the lower limit value range and the upper limit value range illustrated in the screen attribute comparison rule 124M are described as an example of range match.

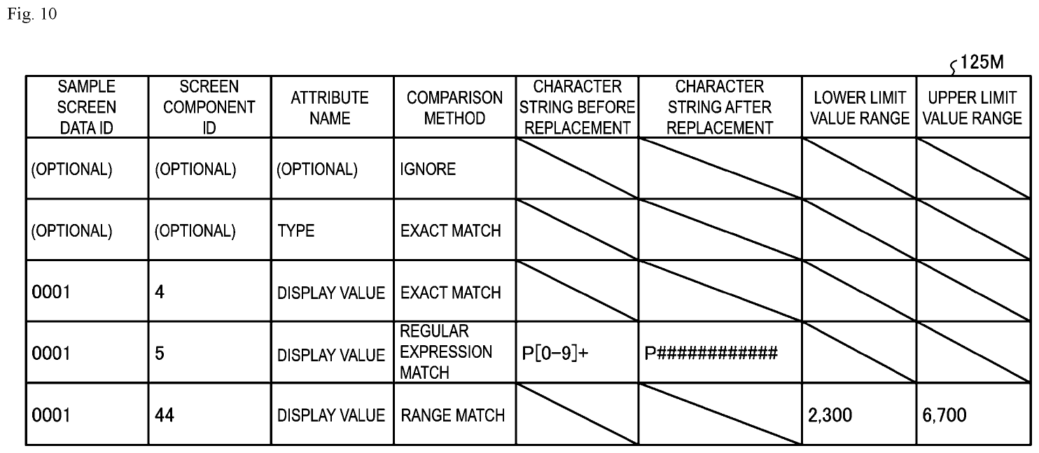

The element attribute comparison rule storage unit 125 stores various comparison rules applied in a case of comparing the attributes of the screen components. FIG. 10 is a diagram illustrating an example of a data configuration of data stored in the element attribute comparison rule storage unit 125. The element attribute comparison rule storage unit 125 stores the screen component attribute comparison rule 125M including the items of the sample screen data ID, the screen component ID, the attribute name, the comparison method, the character string before replacement, the character string after replacement, the lower limit value range, and the upper limit value range. The numerical values of the lower limit value range and the upper limit value range illustrated in the screen component attribute comparison rule 125M are described as an example of range match, and the coordinate values of the display region of the screen component are the main application target.

The identification case storage unit 126 stores screen data identification cases. The identification case storage unit 126 stores the determination results for the equivalence between screen structures of the sample screen data and screen structures of the processing target screen data by the screen structure comparison unit 1314 (at the time of application of option 1-2).

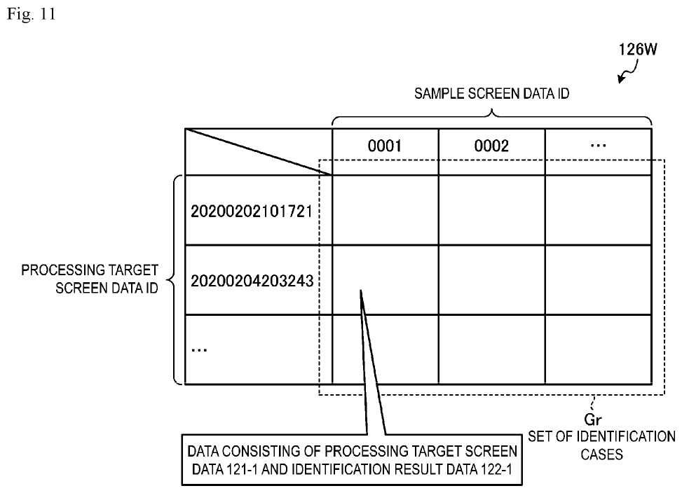

FIG. 11 is a diagram illustrating an example of a data configuration of data stored in the identification case storage unit 126. The identification case storage unit 126 stores a screen data identification case 126W including a set Gr of identification cases. In the identification case Gr, a set of processing target screen data identified as equivalent to each sample screen data and a set of processing target screen data not identified as equivalent are associated with each sample screen data as an example. That is, each field of the screen data identification case 126W is data that consists of the processing target screen data 121-1 and the identification result data 122-1 stored in the identification result storage unit 122.

The control unit 13 includes an internal memory for storing programs and required data in which various processing procedures and the like are defined, and executes various processes with the programs and the data. For example, the control unit 13 is an electronic circuit such as a Central Processing Unit (CPU) or a Micro Processing Unit (MPU). The control unit 13 includes an identification unit 131 and a trimming unit 132 (removing unit) (options 1-1 and 1-2).

The identification unit 131 determines the equivalence of the screens and the screen components for the screen data of the processing target and the sample screen data. The identification unit 131 performs the identification process for determining whether the screen data of the processing target stored in the processing target screen data storage unit 121 is equivalent to each of the sample screen data stored in the identification information storage unit 123. The identification unit 131 saves the identification results in the identification result storage unit 122. The identification unit 131 calls the screen component control unit 22 of the assistance apparatus 20 and outputs the identification results. The identification unit 131 may save the results of determining the equivalences in the identification case storage unit 126. The identification unit 131 includes a processing target reception unit 1311, a sample selection unit 1312, a screen attribute comparison unit 1313 (option 2), a screen structure comparison unit 1314, and an identification result saving unit 1315.

The processing target reception unit 1311 receives the input of the screen data of the processing target output from the assistance apparatus 20 and stores the input in the processing target screen data storage unit 121. The sample selection unit 1312 selects the sample screen data for determining the equivalence from the identification information storage unit 123.

The screen attribute comparison unit 1313 compares the attributes of the screen of the sample screen data and the attributes of the screen of the screen data of the processing target to determine a match or a mismatch. The screen attribute comparison unit 1313 may use comparison rules stored in the screen attribute comparison rule storage unit 124 for the determination of a match or a mismatch in the attributes of the screens (option 2-1).

The screen structure comparison unit 1314 compares the screen structure of the sample and the screen structure of the processing target, and determines whether the screen structures are equivalent. The screen structure comparison unit 1314 determines the equivalence between the screen components of the sample and the screen components of the processing target based on whether a screen component in the screen structure of the sample and a screen component in the screen structure of the processing target have similar relationships to other screen components in the respective screen structures.

The screen structure comparison unit 1314 extracts elements being common portions such that the evaluation of the association method of the screen components is best based on the number of screen components associated with the screen components in the processing target screen structure among all of the screen components of the screen structure of the sample. In addition, the screen structure comparison unit 1314 compares the ratio of the screen components associated with the screen components of the processing target among all of the screen components of the sample with a predetermined threshold value, and determines the equivalence of the screen components.

The screen structure comparison unit 1314 evaluates the association method for associating each screen component of the sample and the screen components of the processing target in the comparison of the screen structures of the sample and the processing target, and performs the association between each screen component of the sample screen data and the screen components of the processing target screen data and the determination of the equivalence by using the best-evaluated association method. At this time, the screen structure comparison unit 1314 may use the number of screen components of the control target extracted from the screen structure of the sample which are associated with the screen components in the screen structure of the processing target, for the evaluation of the association method or the determination of the equivalence (option 4-1). The screen structure comparison unit 1314 may use the number of screen components of the processing target that are subject to the operations, which are screen components associated with the screen components of the control target, for the evaluation of the association method or the determination of the equivalence (option 4-2). The screen structure comparison unit 1314 may repeat the process of deleting a part of the screen components of the processing target associated with the screen components of the screen structure of the sample, and obtaining the association method that gives best evaluation (option 5).

The identification result saving unit 1315 saves the identification results in the identification result storage unit 122. The identification result saving unit 1315 saves the identification results in the identification case storage unit 126 (option 1-2).

The trimming unit 132 trims the screen structure of each sample stored in the identification information storage unit 123 such that the control target screen components and the ancestors and the neighbors thereof remain (at the time of application of option 1-1). The trimming unit 132 removes screen components that do not correspond to any of the screen components of the control target, the ancestors of the screen components of the control target, or the screen components of the neighbors. The trimming unit 132 saves the screen structure of each sample after trimming in the identification information storage unit 123.

The trimming unit 132 specifies and trims portions that do not affect the identification results for the screen structure of each sample stored in the identification information storage unit 123 (at the time of application of option 1-2). In specifying portions that do not affect the identification results in the screen structure of each sample, the trimming unit 132 compares the control target screen components with the ancestors, the descendants, or the neighbors of each of the screen components similar to the control target screen components, and obtains common portions and non-common portions. Alternatively, in specifying portions that do not affect the identification results, the trimming unit 132 obtains common portions and non-common portions by comparison with screen structures of equivalent or non-equivalent screen data accumulated in the identification case storage unit 126. The trimming unit 132 leaves the minimum necessary portions among the non-common portions as the control target identification assisting screen components and the screen identification assisting screen components, and removes other non-common portions from the screen structure of the sample.

The trimming unit 132 saves only the screen structures of the sample whose identification results do not change before and after trimming in the identification information storage unit 123 by using the identification cases accumulated in the identification case storage unit 126 so that the screen structures of the sample can be used in the subsequent identification processes (at the time of application of option 1-2).

### 6. Processing of Identification Apparatus

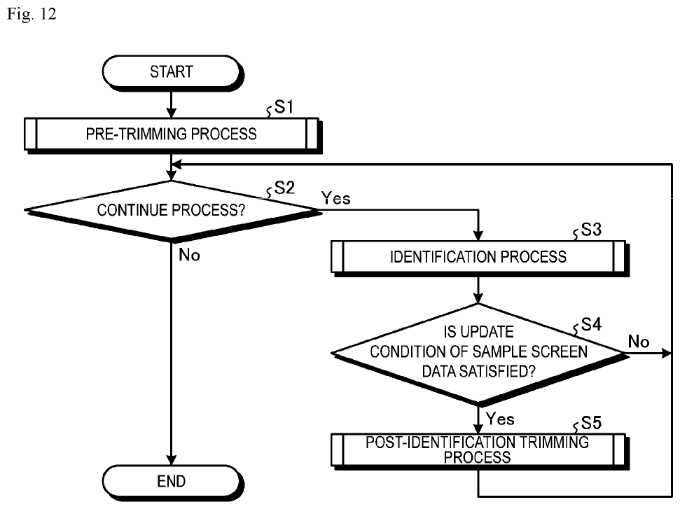

Next, the overview of the processing in the identification apparatus 10 will be described. FIG. 12 is a flowchart illustrating a processing procedure of the processing in the identification apparatus 10 illustrated in FIG. 5.

As illustrated in FIG. 12, in the identification apparatus 10, prior to the identification process in the identification unit 131, the trimming unit 132 performs a pre-trimming process for trimming and updating the screen structure of each sample stored in the identification information storage unit 123 such that the control target screen components or the ancestors or the neighbors thereof remain (step S1) (option 1-1).

In a case where the identification process is not continued (step S2: No), the identification apparatus 10 ends the process. On the other hand, in a case where the identification process is continued (step S2: Yes), in response to calling from the assistance apparatus 20, the identification unit 131 receives input of screen data of processing target, and performs an identification process for determining the equivalence of the screens or the screen components for the screen data of the processing target and the sample screen data (step S3).

Subsequently, the identification apparatus 10 determines whether the update condition of the sample screen data is satisfied (step S4). The update condition is, for example, that the identification case storage unit 126 accumulates data that have not been reflected in the sample screen data in an amount equal to or greater than a predetermined threshold value.

In a case where the update condition of the sample screen data is satisfied (step S4: Yes), the trimming unit 132 performs a post-identification trimming to trim and update the screen structure of each sample stored in the identification information storage unit 123 by using the screen data accumulated in the identification case storage unit 126 (step S5) (option 1-2). In the identification apparatus 10, in a case where the update condition of the sample screen data is not satisfied (step S4: No), or after step S5, the process proceeds to step S2. Note that step S1, step S4, and step S5 may be deleted from FIG. 1, and can be performed independent of the processing in FIG. 1.

### 7. Processing Procedure of Identification Process

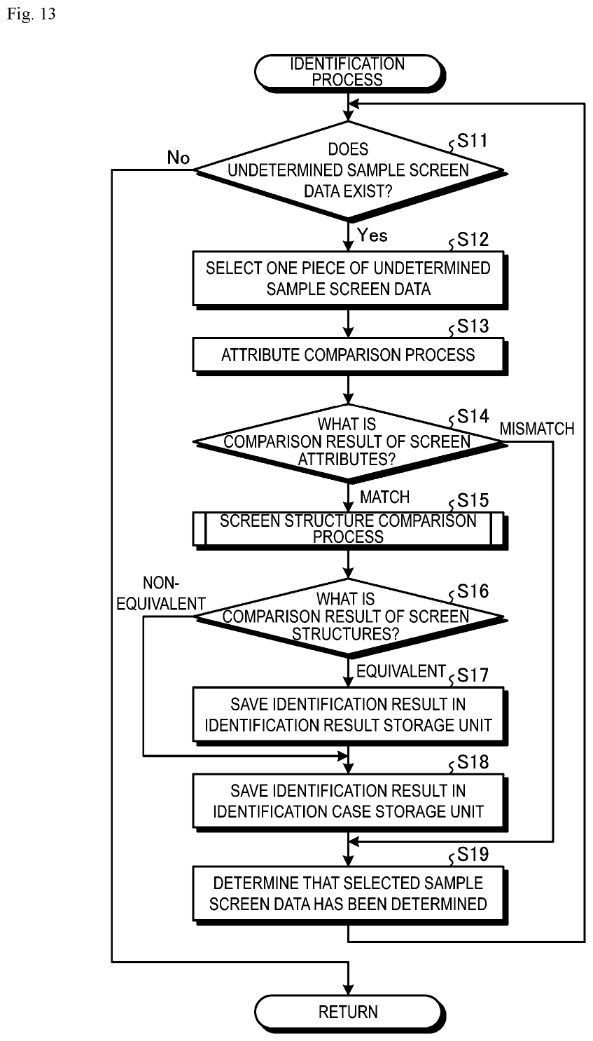

Next, the identification process (step S3) illustrated in FIG. 12 will be described. FIG. 13 is a flowchart illustrating a processing procedure of the identification process illustrated in FIG. 12.

As illustrated in FIG. 13, the identification unit 131 determines whether undetermined sample image data exists (step S11). In a case where undetermined sample image data does not exist (step S11: No), the identification unit 131 ends the identification process.

In a case where undetermined sample image data exists (step S11: Yes, the sample selection unit 1312 selects one piece of undetermined sample screen data from the identification information storage unit 123 (step S12).

In addition, the screen attribute comparison unit 1313 compares the screen attributes of the selected sample screen data and the screen attributes of the processing target screen data, and performs an attribute comparison process for determining a match or a mismatch (step S13) (option 2).

Subsequently, the identification unit 131 determines whether the comparison result of the attributes of the screens is a match or a mismatch (step S14). In a case where the comparison result of the attributes of the screens is the match (step S14: match), the screen structure comparison unit 1314 performs a screen structure comparison process for comparing the screen structure of the processing target and the screen structure of the sample to determine whether the screen structure of the processing target and the screen structure of the sample are equivalent (step S15).

In addition, the identification unit 131 determines whether the comparison result of the screen structures is equivalent or non-equivalent (step S16). In a case where the comparison result of the screen structures is equivalent (step S16: equivalent), the identification result saving unit 1315 saves the identification result in the identification result storage unit 122 (step S17). In a case where the comparison result of the screen structures is non-equivalent (step S16: non-equivalent), or after the process of step S17, the identification result saving unit 1315 saves the identification result in the identification case storage unit 126 (step S18) (option 1-2).

In a case where the comparison result of the attributes of the screens is a mismatch (step S14: mismatch), or after the process of step S18, the identification unit 131 determines that the selected sample screen data has been determined (step S19), and the process proceeds to step S11 in order to determine the equivalence of next sample screen data. Note that the priority of selection may be given to sample screen data in advance depending on the purpose of automation, assistance, or the like of the terminal operations, and the identification unit 131 may terminate the identification process at a stage when screen data determined to be “equivalent” is found.

### 8. Screen Attribute Comparison Process

Next, the screen attribute comparison process (step S13) will be described. In step S13, the screen attribute comparison unit 1313 uses the following first or second screen attribute comparison method.

The first screen attribute comparison method is a method of determining “match” in a case where the attributes representing the class names match, and determining “mismatch” in a case where the attributes do not match, between the screen attributes of the selected sample screen data and the screen attributes of the processing target screen data.

The second screen attribute comparison method (at the time of application of option 2-1) is a method of determining a comparison rule to be applied from among comparison rules held by the screen attribute comparison rule storage unit 124, and determining a match or a mismatch between the attributes of the screen of the selected sample screen data and the attributes of the screen of the processing target screen data, depending on the comparison rule. For example, the screen attribute comparison unit 1313 compares the screen attributes by using the comparison rules shown in Table 1.

TABLE 1
Match and Mismatch of Attribute
Values Based on Comparison Rules

| Comparison | |
|---|---|
| method | Details |
| Exact match | Determine as match in a case where the attribute values |
| | completely match between the sample and the processing |
| | target, and otherwise determine as mismatch. |
| Regular | For each of the attribute values of the sample and the |
| expression | processing target, replace the portions matching the |
| match | regular expression specified in the character string |
| | before replacement with the character string specified |
| | in the character string after replacement. |
| | After that, compare the replaced values with each other, |
| | and determine as match in a case where the values |
| | completely match, and otherwise determine as mismatch. |
| Range match | Determine as match in a case where the attribute |
| | value of the processing target is equal to or greater |
| | than the value obtained by subtracting the lower limit |
| | value range from the attribute value of the sample and |
| | is equal to or less than the value obtained by adding |
| | the upper limit value range to the attribute value |
| | of the sample, and otherwise determine as mismatch. |
| Ignore | Always determine as match regardless of the attribute |
| | values of the sample and the processing target. |

In this case, the screen attribute comparison unit 1313 compares the values of the attributes of the screen of the sample screen data and the values of the attributes of the screen of the processing target screen data, and determines a match or a mismatch in accordance with the comparison rules in Table 1.

For example, the screen attribute comparison unit 1313 determines that the attributes of the screen of the sample screen data and the attributes of the screen of the processing target screen data “match” in a case where it is determined as determined as “match” for all of the values of the attributes of the screens between the sample screen data and the processing target screen data, and otherwise determines as “mismatch”.

Specifically, the screen attribute comparison unit 1313 determines as match in a case where the attribute values completely match for the attribute values of the screen of the sample screen data and the attribute values of the screen of the processing target screen data, and otherwise determines as mismatch (“exact match” in Table 1). For the attribute values of the screen of the sample screen data and the attribute values of the screen of the processing target screen data, the screen attribute comparison unit 1313 replaces the portions matching the regular expression specified in the character string before replacement with the character string specified in the character string after replacement. After that, the screen attribute comparison unit 1313 compares the replaced values with each other, and determines as match in a case where the values completely match, and otherwise determines as mismatch (“regular expression match” in Table 1). The screen attribute comparison unit 1313 determines as match in a case where the attribute value of the screen of the processing target screen data is equal to or greater than the value obtained by subtracting the lower limit value range from the attribute value of the screen of the sample screen data and is equal to or less than the value obtained by adding the upper limit value range to the attribute value of the screen of the sample screen data, and otherwise determines as mismatch (“range match” in Table 1). The screen attribute comparison unit 1313 always determines as match, regardless of the attribute values of the screen of the processing target screen data and the attribute values of the screen of the sample screen data (“ignore” in Table 1).

Note that the comparison rules to be applied are determined, for example, in the following priority.

Priority 1: A comparison rule in which “sample screen data ID” and “attribute name” are not “(arbitrary)” and match the ID of the sample screen data and the attribute name of the comparison target.
Priority 2: A comparison rule in which the “sample screen data ID” is not “(arbitrary)” and matches the ID of the sample screen data of the comparison target.
Priority 3: A comparison rule in which the “attribute name” is not “(arbitrary)” and matches the attribute name of the comparison target.
Priority 4: A comparison rule other than Priorities 1 to 3 and the ID of the sample screen data and the attribute name of the comparison target are corresponding respectively.

### 9. Screen Structure Comparison Process

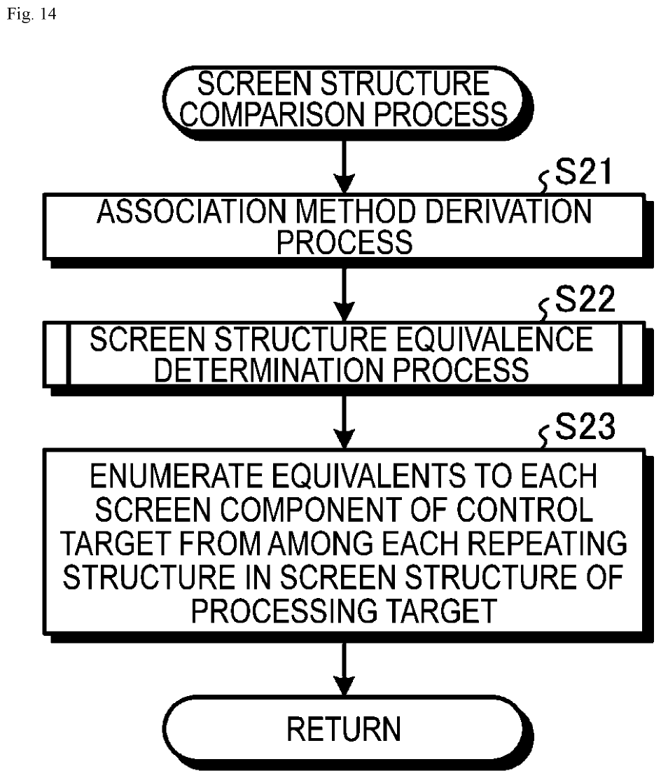

Next, the screen structure comparison process (step S15) illustrated in FIG. 13 will be described. FIG. 14 is a flowchart illustrating a processing procedure of the screen structure comparison process illustrated in FIG. 13.

As illustrated in FIG. 14, the screen structure comparison unit 1314 performs an association method derivation process for obtaining the best-evaluated association method \hat{ }f for the screen structure of the selected sample and the screen structure of the processing target (step S21). The screen structure comparison unit 1314 performs a screen structure equivalence determination process for determining the equivalence of the screen structures based on the association method \hat{ }f obtained in step S21 (step S22).

Here, in a screen structure, like a table and its rows, a partial structure (corresponding to a table, hereinafter referred to as a “repeating structure”) in which a same partial structure (corresponding to a row, hereinafter referred to as a “repeating unit”) repeatedly appears internally may exist, and in a screen structure of a sample, screen components of the control target may be included in the repeating unit.

In specifying equivalents to the screen components of the control target from among the screen components of the processing target, depending on the purpose of automation, assistance, or the like of the terminal operations, variations of requirements including the following, specifically, a single repeating unit association pattern and an all repeating unit association pattern (option 5) are conceivable.

The single repeating unit association pattern specifies only one equivalent to each screen component of the control target from among each repeating structure in the screen structure of the processing target. For example, the single repeating unit association pattern corresponds to a case of specifying only a screen component included in a same repeating unit as a screen component that is subject to the operation of the operator, such as switching ON/OFF of a check box, in the processing target screen data, and assisting the input operation to the screen component. The all repeating unit association pattern specifies all of the equivalents to each screen component of the control target from inside each repeating structure in the screen structure of the processing target. The all repeating unit association pattern corresponds to, for example, a case in which all of the values displayed in the repeating structure of the processing target screen data are acquired and then repeatedly posted to another screen by the number of acquired values (option 5).

In the case of the all repeating unit association pattern, the screen structure comparison unit 1314 specifies the equivalents to the screen components of the control target from among the screen components of the processing target, by enumerating the equivalents to each screen component of the control target from inside each repeating structure in the screen structure of the processing target (step S23) (option 5). At this time, the screen structure comparison unit 1314 writes the ID number and the unit of the repeating structure in the repeating structure ID column and the repeating unit ID column of the attribute 123A of the screen components of the identification result storage unit 122. Hereinafter, methods for comparing screen structures corresponding to these two patterns will be described in detail.

9.1. Single Repeating Unit Association Pattern

The single repeating unit association pattern will be described. A screen structure is represented as a graph structure or a tree structure with each screen component as a vertex and a direct relationship existing between some screen components as an edge (see, for example, the screen structure 121C in FIG. 6).

In the following description, the set of vertices in the screen structure of the sample is referred to as Vᵣ, the set of edges in the screen structure of the sample is referred to as Eᵣ (⊆Vᵣ×Vᵣ), the set of vertices in the screen structure of the processing target is referred to as Vₜ, and the set of edges in the screen structure of the processing target is referred to as Eₜ (⊆Vₜ×Vₜ). Note that, in a case where there are orientations in the edges, the edges are distinguished as different sources from Eᵣ and Eₜ. Screen components and vertices are not distinguished for the sake of explanation. The screen structure of the sample is referred to as Sᵣ=(Vᵣ, Eᵣ), and the screen structure of the processing target is referred to as Sₜ=(Vₜ, Eₜ).

In comparison of the screen structures between the sample and the processing target, a vertex v (∈Vᵣ) corresponding to each screen component of the sample is associated with a vertex u (∈Vₜ) corresponding to up to one screen component of the processing target so as not to overlap. This method of associating vertices with each other corresponds to an injective partial mapping (or total mapping) f (see Relationship (1)).

[Math. 1]

f:Vᵣ [symbol] Vₜ (1)

The set of screen components of the sample associated with any of the screen components of the processing target is represented as Def(f). The set of screen components of the processing target associated with the screen components of the sample is represented as Img(f).

In a case where the screen configuration comparison unit 1314 compares the screen structures of the sample and the processing target and obtains the common partial structures, the method is limited to the one in which the presence or absence of the edges is maintained before and after the association for combination of each vertex to be associated, that is, the one satisfying Relationship (2), among these association methods.

[Math. 2]

∀vᵢ,∀vⱼ∈Def(f)(⊆Vᵣ),(vᵢ,vⱼ)∈Eᵣ⇔(f(vᵢ),f(vⱼ))∈Eₜ (2)

In a case where the screen structure is a directed order tree, it is possible to obtain the association method \hat{ }f that maximizes the number of screen components |Def(f)| included in Def(f) in the calculation order of the product of the number of screen components of the sample screen data and the number of screen elements of the processing target screen data, for example, by using the algorithm for a directed order tree described in Reference 1.
(Reference 1) “Algorithms for Finding One of the Largest Common Subgraphs of Two Trees”, 1994, Sumio Masuda et al., The transactions of the Institute of Electronics, Information and Communication Engineers. A, 77 (3), 460-470, 1994-03-25.

Note that in the algorithm described in Reference 1, all vertices are treated as equivalent in each vertex alone ignoring the relationship with other vertices, but in the present embodiment, it is assumed that the screen components have at least attributes representing the types, and different types of screen components cannot be equivalent to each other. Thus, in the present embodiment, the association method is obtained under the constraint condition that only the screen components that can be equivalent can be associated with each other.

Whether the screen components can be associated with each other is determined by the following first or second method. The first method is a method of determining as “association possible” in a case where the values of the attributes representing the types among the attributes of the screen components match, and otherwise determining as “association impossible”.

In the second method (at the time of application of option 3), the comparison rule to be applied is determined from among the comparison rules held in the element attribute comparison rule storage unit 125 for each attribute of the screen component. The second method compares the values of the attributes of the screen components of the sample and the values of the attributes of the screen components of the processing target, and determines a match or a mismatch according to the determined comparison rule as in Table 1. The second method determines as “association possible” for the screen components with each other in a case where the screen components are determined as determined as “match” for all attributes, and otherwise determines as “association impossible” for the screen components with each other.

Note that the comparison rules to be applied in the second method are determined, for example, in the following priority.

Priority 1: A comparison rule in which “sample screen data ID”, “screen component ID”, and “attribute name” are not “(arbitrary)” and match the ID of the sample screen data, the ID of the screen component, and the attribute name of the comparison target.
Priority 2: A comparison rule in which “sample screen data ID” and “screen component ID” are not “(arbitrary)” and match the ID of the sample screen data and the ID of the screen component of the comparison target.
Priority 3: A comparison rule in which the “attribute name” is not “(arbitrary)” and matches the attribute name of the comparison target.
Priority 4: A comparison rule other than Priorities 1 to 3, and the ID of the sample screen data, the ID of the screen component, and the attribute name of the comparison target are corresponding respectively.

In the present embodiment, the association method is obtained under the constraint condition that the root screen component of the screen structure of the sample can be associated only with the root screen component of the screen structure of the processing target.

Further, in reference 1, the association method f between the partial structures is evaluated based on the magnitude of the number of vertices |Def(f)| associated by using the association method f, that is, the screen components included in Def(f). Similarly, in the present embodiment, the evaluation may be made based on the magnitude of the number of screen components included in the common partial structures, or an evaluation method that reflects some or all of the following first and second aspects may be used.

The first aspect is to associate the screen components of the control target among the screen components of the sample with the screen components of the processing target with priority over other screen components. Thus, assuming that the set of screen components of the control target is ˜Vᵣ (⊆Vᵣ), the association method f is evaluated based on the magnitude of |Def(f)∩˜Vᵣ|.

The second aspect is to associate the screen components that are subject to the operations by the operator in the processing target screen data with the screen components of the control target in the screen structure of the sample with priority over screen components in other rows, in a screen structure in which the same partial structure appears repeatedly like a row in a table. Thus, assuming that the set of screen components that are subject to the operations by the operator is V^{op}ₜ(⊆Vₜ), the association method f is evaluated based on the magnitude of |f(˜Vᵣ)∩˜V^{op}ₜ|.

Note that the evaluation method of the association method is similarly applied not only to the final association method targeted for the entire screen structure of the sample and the entire screen structure of the processing target, but also to an association method f′ (see Relationship (3)) targeted for each partial structure with arbitrary Vᵣ′(⊆Vᵣ) and Vₜ′(⊆Vₜ) as sets of vertices, which are handled in the process of obtaining the final association method. Specifically, by replacing only the evaluation method with the algorithm of Reference 1 of the citation, it is possible to obtain the association method \hat{ }f that gives the best evaluation in the evaluation method. The evaluation method itself does not depend on whether the screen composition has a graph structure or a tree structure.

[Math. 3]

f′:V′ᵣ [symbol] V′ₜ (3)

9.1.1 Association Method Derivation Process

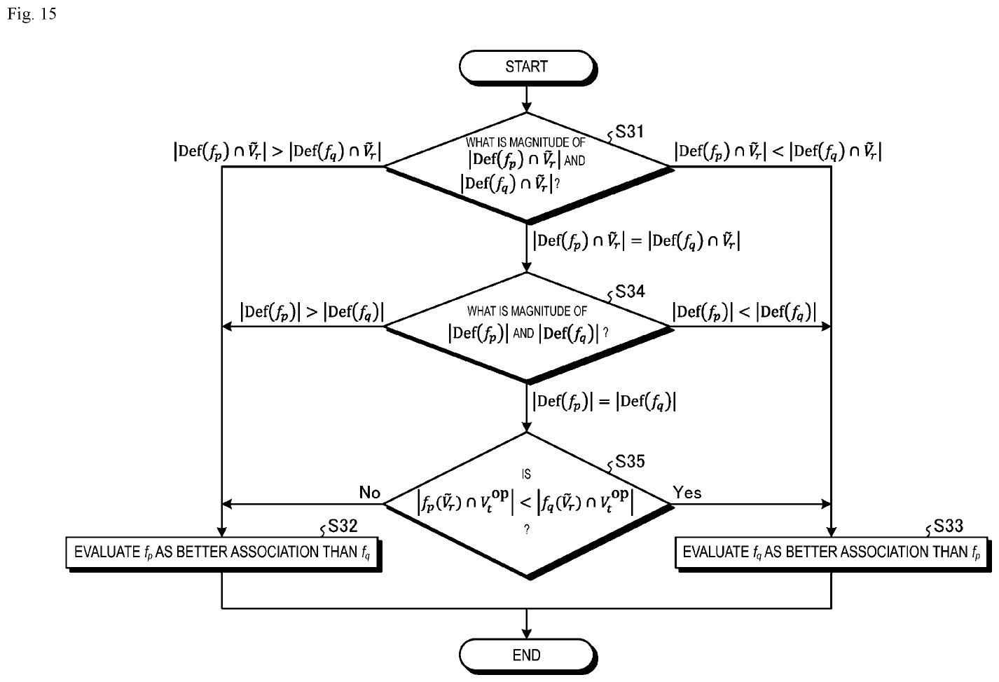

The algorithm described in Reference 1 can be applied to the association method derivation process. In the algorithm, in the present embodiment, the process illustrated in FIG. 15 below can be replaced with a process for evaluating an association method in Reference 1. Thus, the process of FIG. 15 will be described. FIG. 15 is a flowchart illustrating a processing procedure of a process for evaluating an association method in an association method derivation process. In FIG. 15, a case of evaluating which of the association methods fₚ and f_{q} is the better method will be described as an example.

First, the screen structure comparison unit 1314 determines the magnitude of |Def(fₚ)∩˜Vᵣ| and |Def(f_{q})∩˜Vᵣ| in order to evaluate the association methods fₚ and f_{q} from the first aspect (step S31) (at the time of application of option 4-1).

In a case where |Def(fₚ)∩˜Vᵣ|>|Def(f_{q})∩˜Vᵣ| (step S31: |Def(fₚ)∩˜Vᵣ|>|Def(f_{q})∩˜Vᵣ|, the screen structure comparison unit 1314 evaluates the association method fₚ as a better association method than f_{q} (step S32). In a case where |Def(fₚ)∩˜Vᵣ|<|Def(f_{q})∩˜Vᵣ| (step S31: |Def(fₚ)∩˜Vᵣ|<|Def(f_{q})∩˜Vᵣ|, the screen structure comparison unit 1314 evaluates the association method f_{q} as a better association method than fₚ (step S33).

In a case where |Def(fₚ)∩˜Vᵣ|=|Def(f_{q})∩˜Vᵣ| (step S31: |Def(fₚ)∩˜Vᵣ|=|Def(f_{q})∩˜Vᵣ|), the screen structure comparison unit 1314 determines the magnitude of |Def(fₚ)| and |Def(f_{q})| (step S34). This is the same as the determination process in a case where the algorithm described in Cited Document 1 is applied as is.

In a case where |Def(fₚ)|>|Def(f_{q})| (step S34: |Def(fₚ)|>Def(f_{q})|), the screen structure comparison unit 1314 evaluates the association method fₚ as a better association method than f_{q}(step S32). In a case where |Def(fₚ)<|Def(f_{q})| (step S34: |Def(fₚ)<|Def(f_{q})|), the screen structure comparison unit 1314 evaluates the association method f_{q} as a better association method than fₚ (step S33).

In addition, in a case where |Def(fₚ)|=|Def(f_{q})| (step S34: |Def(fₚ)|=|Def(f_{q})|), the screen structure comparison unit 1314 determines whether |fₚ(˜Vᵣ)∩˜V^{op}ₜ|<|f_{q}(˜Vᵣ)∩˜V^{op}ₜ| in order to evaluate the association methods fₚ and f_{q} from the second aspect (step S35) (at the time of application of option 4-2).

In a case where |fₚ(˜Vᵣ)∩˜V^{op}ₜ|<f_{q}(˜Vᵣ)∩˜V^{op}ₜ| (step S35: Yes), the screen structure comparison unit 1314 evaluates the association method f_{q} as a better association method than fₚ (step S33). In a case where not |fₚ(˜Vᵣ)∩˜V^{op}ₜ|<|f_{q}(˜Vᵣ)∩˜V^{op}ₜ| (step S35: No), that is, in a case where |fₚ(˜Vᵣ)∩˜V^{op}ₜ|≥|f_{q}(˜Vᵣ)∩˜V^{op}ₜ|, the screen structure comparison unit 1314 evaluates the association method fₚ as a better association method than f_{q} (step S32). The screen structure comparison unit 1314 can obtain the best-evaluated association method \hat{ }f by performing the association method evaluation process illustrated in FIG. 15 for the association method of the evaluation target.

9.1.2. Screen Structure Equivalence Determination Process

The screen structure comparison unit 1314 determines whether the screen structures of the sample screen data and the processing target image data are equivalent by comparison with a predetermined threshold value for each evaluation aspect of the best association method \hat{ }f obtained in the association method evaluation process illustrated in FIG. 15.

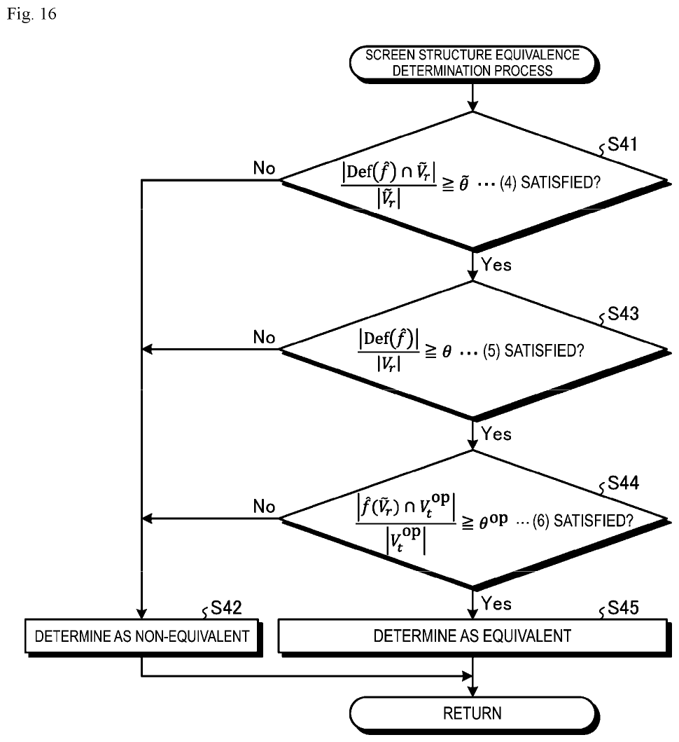

Next, the screen structure equivalence determination process (step S22) of FIG. 14 will be described. FIG. 16 is a flowchart illustrating a processing procedure of the screen structure equivalence determination process illustrated in FIG. 14.

As illustrated in FIG. 16, the screen structure comparison unit 1314 determines whether the ratio of the number of elements included in both the set of screen components (Def(\hat{ }f)) associated by using the association method \hat{ }f and the set of screen components (˜Vᵣ) of the control target to the number of elements in the set of screen components (˜Vᵣ) of the control target is equal to or greater than a predetermined threshold value ˜θ, that is, whether Relationship (4) is satisfied (step S41).

$$[ Math . 4 ]$$

$$\frac{\vert Def ( \hat{f} ) ⋂ {\tilde{V}}_{r} \vert}{\vert {\tilde{V}}_{r} \vert} ≧ \tilde{θ} \qquad ( 4 )$$

In a case where Relationship (4) is not satisfied (step S41: No), the screen structure comparison unit 1314 determines that the screen structure of the sample and the screen structure of the processing target are non-equivalent (step S42).

On the other hand, in a case where Relationship (4) is satisfied (step S41: Yes), the screen structure comparison unit 1314 determines whether the ratio of the number of screen components (Def(\hat{ }f)) associated by using the association method \hat{ }f to the number of elements in the set (Vᵣ) of (all of) the screen components of the sample is equal to or greater than a predetermined threshold value θ, that is, whether Relationship (5) is satisfied (step S43).

$$[ Math . 5 ]$$

$$\frac{\vert Def ( \hat{f} ) \vert}{\vert {V}_{r} \vert} ≧ θ \qquad ( 5 )$$

In a case where Relationship (5) is not satisfied (step S43: No), the screen structure comparison unit 1314 determines that the screen structure of the sample and the screen structure of the processing target are non-equivalent (step S42).

On the other hand, in a case where Relationship (5) is satisfied (step S43: Yes), the screen structure comparison unit 1314 determines whether the ratio of the number of elements included in both the set of screen components of the processing target (\hat{ }f(˜Vᵣ)) associated with the sample by using the association method \hat{ }f and the set of screen components (V^{op}ₜ) that are subject to the operations by the operator to the number of elements in the set of screen components (V^{op}ₜ) that are subject to the operations by the operator is equal to or greater than a predetermined threshold value θ^{op}, that is, whether Relationship (6) is satisfied (step S44).

$$[ Math . 6 ]$$

$$\frac{\vert \hat{f} ( {\tilde{V}}_{r} ) ⋂ {V}_{t}^{op} \vert}{\vert {V}_{t}^{op} \vert} ≧ {θ}^{op} \qquad ( 6 )$$

In a case where Relationship (6) is not satisfied (step S44: No), the screen structure comparison unit 1314 determines that the screen structure of the sample and the screen structure of the processing target are non-equivalent (step S42). On the other hand, in a case where Relationship (6) is satisfied (step S44: Yes), the screen structure comparison unit 1314 determines that the screen structure of the sample and the screen structure of the processing target are equivalent (step S45).

Note that the screen structure comparison unit 1314 may use a common threshold value for all of the sample screen data as each threshold value, or may use a threshold value defined for each of the sample screen data (option 6).

In FIG. 16, as a process for comparing the screen structures of the sample and the processing target, the screen structure comparison unit 1314 obtains the best association method \hat{ }f by comparison, and then determines the equivalence of the screen structures of the sample and the processing target. On the other hand, in a configuration where the best association method \hat{ }f is not necessary in a case where the screen structures are not equivalent (at the time of not applying option 1-2), that is, in a case where the post-identification trimming process is not applied, the screen structure comparison unit 1314 may terminate the comparison process at the time when it is found that the ratio is below the threshold value and determine as “non-equivalent”.

9.2. All Repeating Unit Association Pattern

### 9.2.1. Extended Form

First, a case in which an arbitrary number of one-layer repeating structures are included in the all repeating unit association pattern will be described in a form of extending the single repeating unit association pattern.

Hereinafter, in the screen structure of the sample, a partial structure corresponding to an arbitrary k-th (where k≥1) repeating structure in the first layer is defined as ˜S*ᵣ₍ₖ₎=(˜V*ᵣ₍ₖ₎, ˜E*ᵣ₍ₖ₎), and further, in the partial structure, a partial structure corresponding to a repeating unit is defined as ˜S**ᵣ₍ₖ₎=(˜V**ᵣ₍ₖ₎, ˜E**ᵣ₍ₖ₎), and a set of screen components of the control target included in the repeating unit is defined as ˜Vᵣ₍ₖ₎.

Note that it is assumed that not only the screen components of the control target but also the repeating structure and one repeating unit for each repeating structure are specified in advance, and at that time, it is assumed that all of the screen components of the control target included in each set ˜Vᵣ₍ₖ₎ are included inside a single repeating unit. However, there may be screen components of the control target that are included in the repeating structure but not included in the repeating unit, and a set of such screen components is defined as ˜V^{odd}ᵣ₍ₖ₎.

In a case where the screen structure is a directed tree, root screen components of subtrees ˜S*ᵣ₍ₖ₎ and ˜S**ᵣ₍ₖ₎ are referred to as a base point of the repeating structure ˜v*ₖ and a base point of the repeating unit ˜v**ₖ, respectively. As a method in which the repeating structure and the repeating unit are specified in advance, the sets ˜V*ᵣ₍ₖ₎ and ˜V**ᵣ₍ₖ₎ may be specified. In a case where the screen structures are directed trees, the base points ˜v*ₖ and ˜v**ₖ may be specified instead.

Among the screen components of the control target included in the set ˜Vᵣ, a set of those not included in any of repeating structures is defined as ˜Vᵣ₍₀₎.

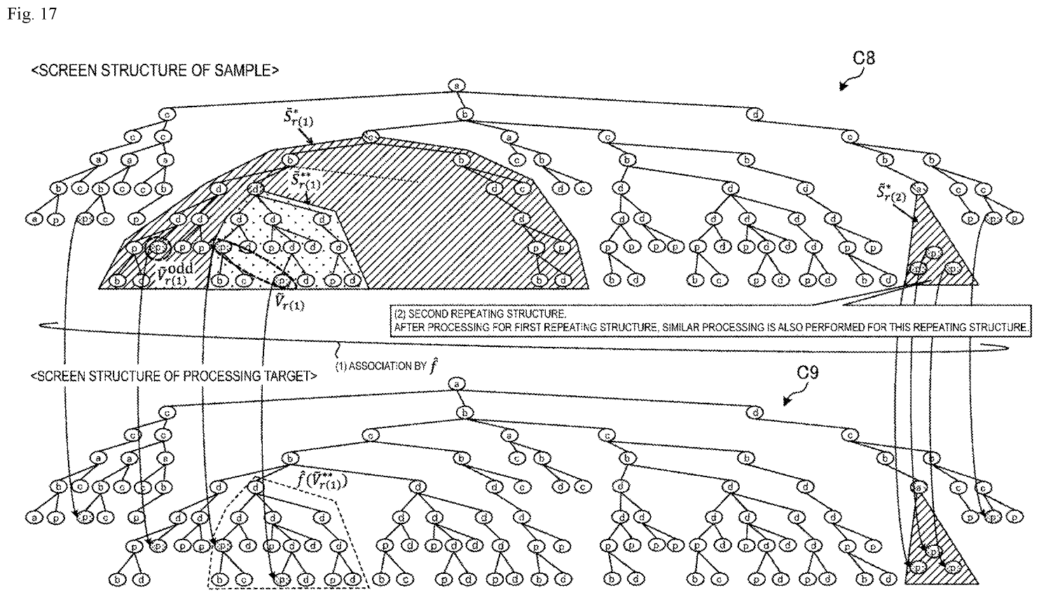

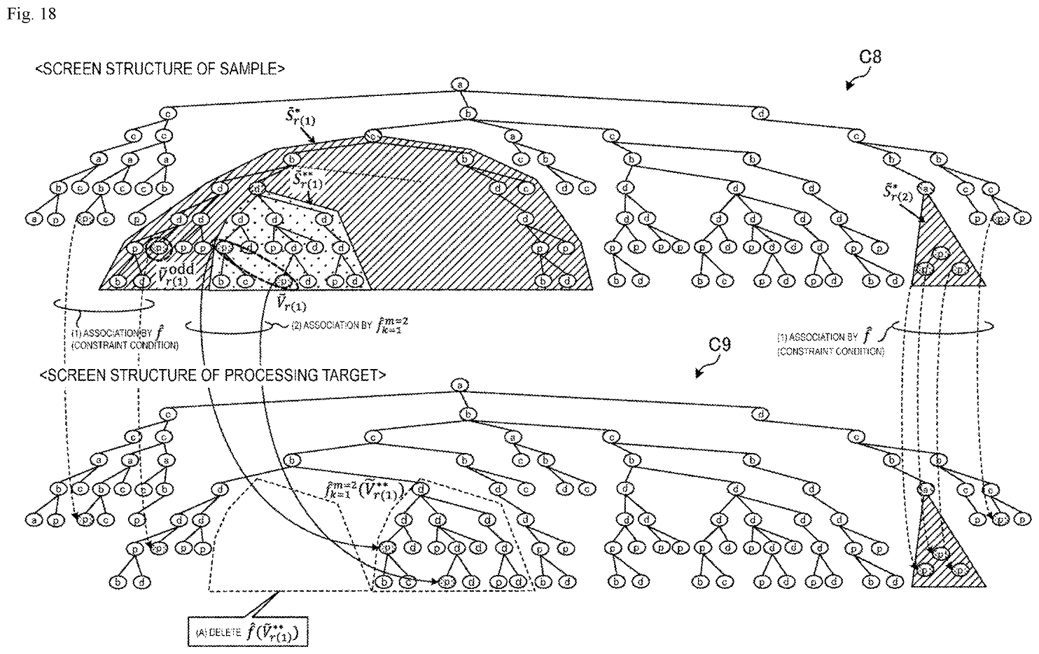

FIGS. 17 and 18 are diagrams for explaining enumeration of repeating units in a case where the repeating structure has one layer. In FIGS. 17 and 18, a case in which the screen structure C8 of the sample and the screen structure C9 of the processing target are compared is illustrated as an example.

Even in a case of specifying all of the equivalents to the screen components of the control target in the repeating structure ˜S*ᵣ₍ₖ₎, first, the screen structure comparison unit 1314 performs comparison by the single repeating unit association pattern for the entire screen structure, and obtains the best association method \hat{ }f. The screen structure comparison unit 1314 performs association according to the obtained association method \hat{ }f (see (1) in FIG. 17), and specifies up to one equivalent in the screen structure of the processing target for each screen component of the control target.

The screen structure comparison unit 1314 does not need to obtain any more equivalent screen components for the screen components included in the set ˜V^{odd}ᵣ₍ₖ₎. After that, as illustrated in FIGS. 17 and 18, the screen structure comparison unit 1314 enumerates other equivalents in the screen structure of the processing target for the screen components of the control target included in each set ˜Vᵣ₍ₖ₎ (where k≥1).

For an arbitrary set ˜Vᵣ₍ₖ₎ where k≥1, in a case where all of the screen components included in the set ˜Vᵣ₍ₖ₎ are associated with any of the screen components in the screen structure of the processing target by the best association method \hat{ }f, that is, in a case of Relationship (7), the screen structure comparison unit 1314 deletes all of the screen components in the screen structure of the processing target associated with the screen components ˜V**ᵣ₍ₖ₎ in the repeating unit ˜S**ᵣ₍ₖ₎, that is, \hat{ }f (˜V**ᵣ₍ₖ₎) (hereinafter referred to as the “repeating unit in the screen structure of the processing target”) (see (A) in FIG. 18).

$$[ Math . 7 ]$$

$$\frac{\vert Def ( \hat{f} ) ⋂ {\tilde{V}}_{r ( k )} \vert}{\vert {\tilde{V}}_{r ( k )} \vert} = 1 \qquad ( 7 )$$

After that, under the constraint condition that all of the screen components of the control target not included in the set ˜Vᵣ₍ₖ₎ are associated in the same way as the best association method \hat{ }f (see (1) in FIG. 18), the screen structure comparison unit 1314 again performs comparison by the single repeating unit association pattern for the screen structures of the sample and the processing target, and obtains the best association method \hat{ }f²ₖ. Association is performed according to the association method \hat{ }f²ₖ (see (2) in FIG. 18).

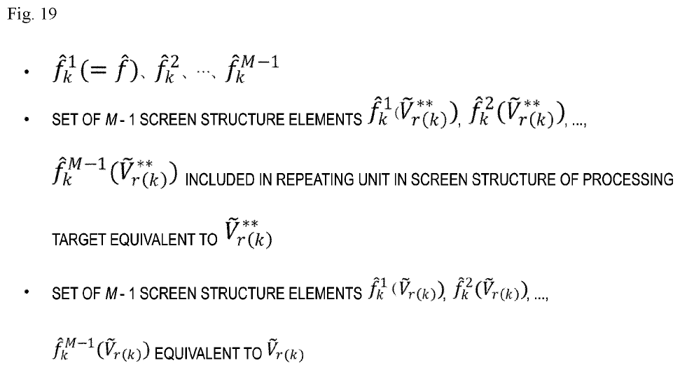

FIG. 19 is a diagram for explaining computation results acquired by the screen configuration comparison unit 1314. The results illustrated in FIG. 19 are obtained by repeating the above process until Relationship (8) is obtained.

$$[ Math . 8 ]$$

$$\frac{\vert Def ( {\hat{f}}_{k}^{M} ) ⋂ {\tilde{V}}_{r ( k )} \vert}{\vert {\tilde{V}}_{r ( k )} \vert} < 1 ( Where M \geq 2 ) \qquad ( 8 )$$

9.2.2. General Form

Next, a general case in which an arbitrary number of repeating structures with an arbitrary number of layers nested are included in the all repeating unit association pattern will be described.

Even in the case where the repeating structure is nested, the screen configuration comparison unit 1314 performs comparison by the single repeating unit association pattern for the entire screen structure, obtains the best association method \hat{ }f, and specifies up to one equivalent in the screen structure of the processing target for each screen component of the control target. As a result, for each repeating structure of each layer, a set of screen components equivalent to screen components that are included in the repeating structure but not included in the repeating unit in the screen structure of the processing target, and a partial structure corresponding to the first repeating unit are obtained.

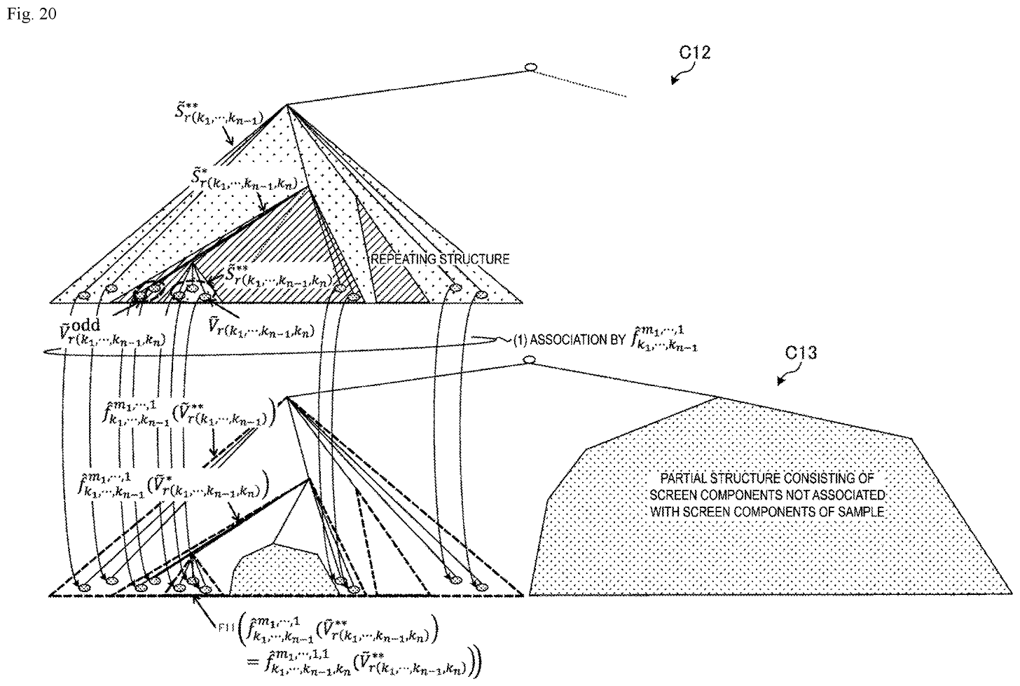

FIGS. 20 to 25 are diagrams for explaining enumeration of repeating units in a case where the repeating structure has a plurality of layers. In FIGS. 20 to 25, a case in which the screen structure C12 of the sample and the screen structure C13 of the processing target are compared is illustrated as an example.

After that, as illustrated in FIGS. 20 to 25, each time the screen configuration comparison unit 1314 finds a partial structure equivalent to the repeating unit in the screen structure of the processing target in an upper layer, the screen configuration comparison unit 1314 recursively repeats the process of enumerating a set of screen components equivalent to screen components that are included in the repeating structure but not included in the repeating unit, and partial structures equivalent to the repeating unit, in each repeating structure of each lower layer for each partial structure. Details of the process will be described below.

For a kₙ-th repeating structure (where kₙ≥1) of an arbitrary n-th layer in C12 in the screen structure of the sample, a partial structure corresponding to the repeating structure is defined as ˜S*_{r(k1, . . . , kn-1, kn)}=(˜V*_{r(k1, . . . , kn-1, kn)}, ˜E*_{r(k1, . . . , kn-1, kn)}), and further, in the partial structure, a partial structure corresponding to the repeating unit is defined as ˜S**_{r(k1, . . . , kn-1, kn)}=(˜V**_{r(k1, . . . , kn-1, kn)}, ˜E**_{r(k1, . . . , kn-1, kn)}), a set of screen components of the control target that are included in the repeating unit is defined as ˜V_{r(k1, . . . , kn-1, kn)}, and a set of screen components of the control target that are included in the repeating structure but not included in the repeating unit is defined as ˜V^{odd}_{r(k1, . . . , kn-1, kn)} (see, for example, C12 in FIG. 20). In this case, each set is Relationships (9) to (12).

[Math. 9]

\tilde{V}ᵣ₍ₖ_{₁}_{, . . . ,k}_{ₙ₋₁}_{,k}_{ₙ}₎⊂\tilde{V}ᵣ₍ₖ_{₁}_{, . . . ,k}_{ₙ₋₁}₎ (9)

[Math. 10]

\tilde{V}ᵣ₍ₖ_{₁}_{, . . . ,k}_{ₙ₋₁}_{,k}_{ₙ₎}^{odd}⊂\tilde{V}ᵣ₍ₖ_{₁}_{, . . . ,k}_{ₙ₋₁}₎ (10)

[Math. 11]

\tilde{V}*ᵣ₍ₖ_{₁}_{, . . . ,k}_{ₙ₋₁}_{,k}_{ₙ}₎⊂\tilde{V}*ᵣ₍ₖ_{₁}_{, . . . ,k}_{ₙ₋₁}₎ (11)

[Math. 12]

\tilde{V}**ᵣ₍ₖ_{₁}_{, . . . ,k}_{ₙ₋₁}_{,k}_{ₙ}₎⊂\tilde{V}**ᵣ₍ₖ_{₁}_{, . . . ,k}_{ₙ₋₁}₎ (12)

9.2.2.1. Processing for Repeating Structure of Bottom Layer

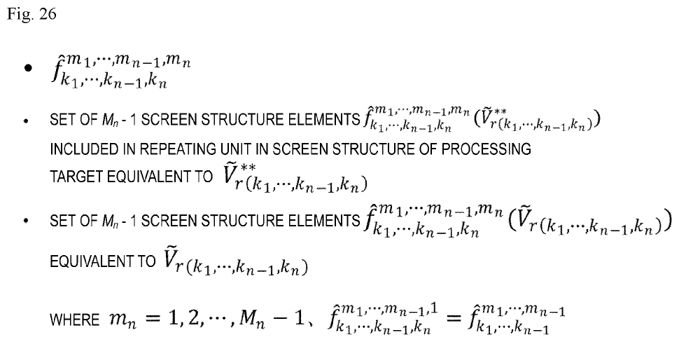

FIG. 26 is a diagram for explaining computation results acquired by the screen configuration comparison unit 1314. In a case where the repeating structure ˜S*_{r(k1, . . . , kn-1, kn)} does not have a repeating structure therein, the screen configuration comparison unit 1314 performs the extended form of processing and obtains the results illustrated in FIG. 26.

9.2.2.2. Processing for Repeating Structure Other Than Bottom Layer

In a case where the repeating structure ˜S*_{r(k1, . . . , kn-1)} has repeating structures therein, the screen configuration comparison unit 1314 defines the internal repeating structures as ˜S*_{r(k1, . . . , kn-1, 1)}, ˜S*_{r(k1, . . . , kn-1, 2)}, ˜S*_{r(k1, . . . , kn-1, kn)}.

First, for each repeating structure ˜S*_{r(k1, . . . , kn-1, kn)} in the first repeating unit in the screen structure of the processing target which is equivalent to the repeating unit ˜S**_{r(k1, . . . , kn-1)}, the screen configuration comparison unit 1314 enumerates all of the partial structures equivalent to (set of screen components included in) the repeating unit ˜S**_{r(k1, . . . , kn-1, kn)}, and the screen components equivalent to the screen components of the control target ˜V_{r(k1, . . . , kn-1, kn)} by the following process.

In a case where the repeating structure ˜S*_{r(k1, . . . , kn-1, kn)} does not have a repeating structure therein, the screen configuration comparison unit 1314 performs the processing for the repeating structure of the bottom layer.

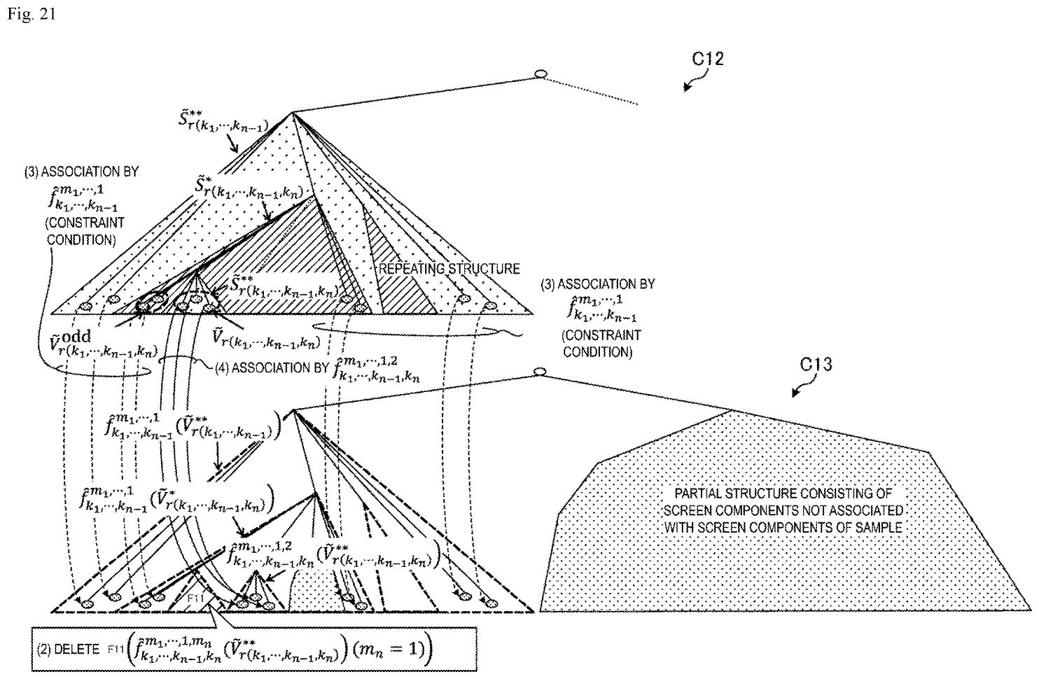

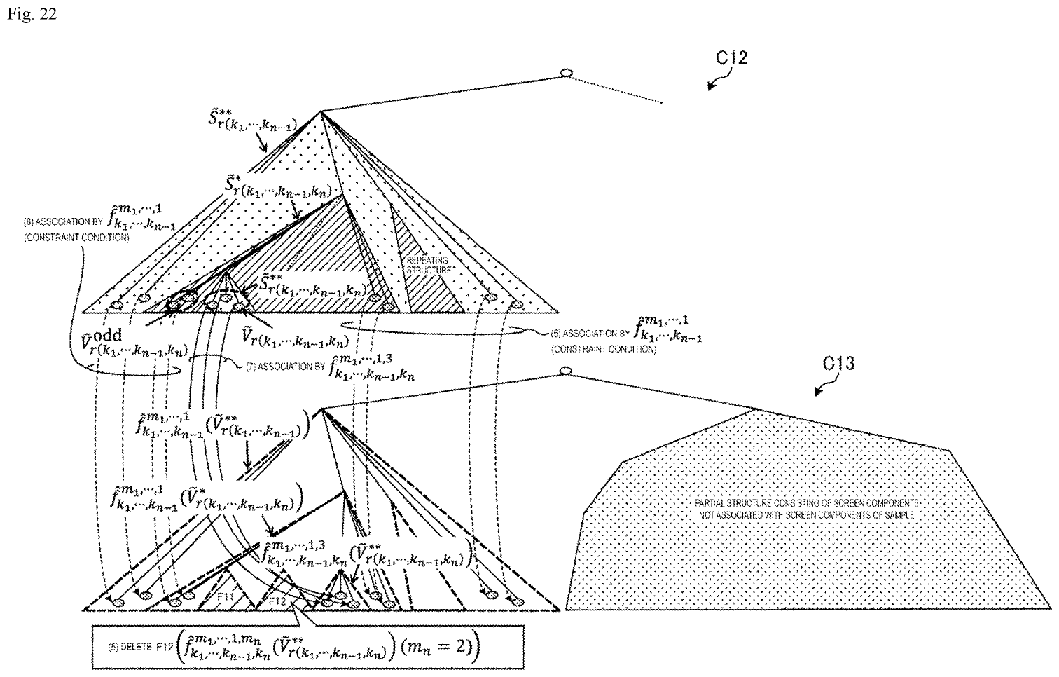

For example, the screen configuration comparison unit 1314 deletes all of the screen components included in the first repeating unit in the screen structure of the processing target \hat{ }f^{m1, . . . , 1, 1}_{k1, . . . , kn-1, kn} (˜V**_{rr(k1, . . . , kn-1, kn)}) (see F11 in FIG. 21) associated according to the association method \hat{ }f^{m1, . . . , 1, 1}_{k1, . . . , kn-1, kn} (=\hat{ }f^{m1, . . . , 1}_{k1, . . . , kn-1}) in the repeating structure of the bottom layer (see (2) in FIG. 21). Subsequently, under the constraint condition (see (3) in FIG. 21) that all of the screen components of the control target screen data that are not included in ˜V_{r(k1, . . . , kn-1, kn)} are associated in the same way as the best association method \hat{ }f^{m1, . . . , 1}_{k1, . . . , kn-1}, the screen configuration comparison unit 1314 obtains the association method \hat{ }f^{m1, . . . , 1,2}_{k1, . . . , kn-1, kn} (see (4) in FIG. 21), and obtains (a set of screen components included in) the second partial structure in the screen structure of the processing target \hat{ }f^{m1, . . . , 1, 2}_{k1, . . . , kn-1, kn}(˜V**_{r(k1, . . . , kn-1, kn)}) (see F12 in FIG. 22), which is equivalent to the repeating unit ˜S**_{r(k1, . . . , kn-1, kn)} in the repeating structure ˜S*_{r(k1, . . . , kn-1, kn)}, and screen components \hat{ }f^{m1, . . . , 1, 2}_{k1, . . . , kn-1, kn} (˜V_{r(k1, . . . , kn-1, kn)}) equivalent to the screen components of the control target ˜V_{r(k1, . . . , kn-1, kn)}. Subsequently, the screen configuration comparison unit 1314 deletes all of the screen components included in the second repeating unit \hat{ }f^{m1, . . . , 1, 2}_{k1, . . . , kn-1, kn}(˜V*_{r(k1, . . . , kn-1, kn)}) (see F12 in FIG. 22) in the screen structure of the processing target (see (5) in FIG. 22). After that, the screen configuration comparison unit 1314 repeats similar processing until no repeating units in the screen structure of the processing target are found.

In a case where the repeating structure ˜S*_{r(k1, . . . , kn-1, kn)} has repeating structures therein, the screen configuration comparison unit 1314 recursively performs the processing for the repeating structure other than the bottom layer.

Note that a set of screen components equivalent to the screen components ˜V^{odd}_{r(k1, . . . , kn-1, kn)} that are included in the repeating structure but not included in the repeating unit is obtained at the stage when the first repeating unit in the screen structure of the processing target is obtained.

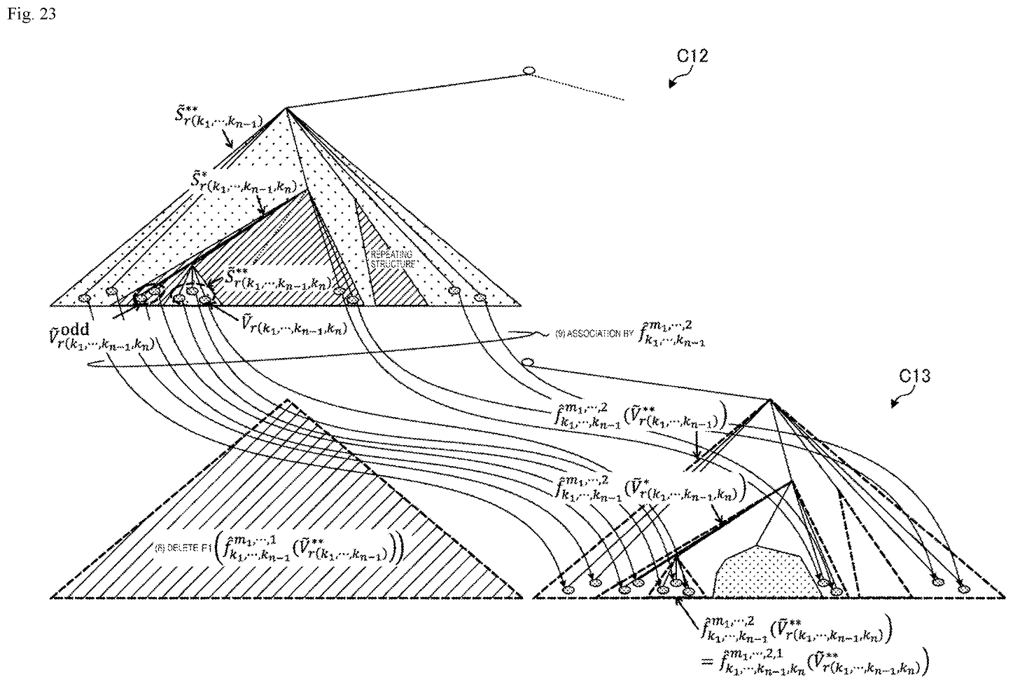

After that, the screen configuration comparison unit 1314 deletes all of the screen components \hat{ }f^{m1, . . . , 1}_{k1, . . . , kn-1} (˜V**_{r(k1, . . . , kn-1)}) (screen components F1 in FIG. 23) included in the first repeating unit in the screen structure of the processing target, which is equivalent to the repeating unit ˜S**_{r(k1, . . . , kn-1), obtained by the association according to the association method \hat{ }f}^{m1, . . . , 1}_{k1, . . . , kn-1} (see (8) in FIG. 23).

Then, under the constraint condition that all of the screen components of the control target screen data that are not included in ˜V_{r(k1, . . . , kn-1)} are associated in the same way as the best association method \hat{ }f^{m1, . . . , 1}_{k1, . . . , kn-1}, the screen configuration comparison unit 1314 again performs comparison by the single repeating unit association pattern for the screen structure C12 of the sample and the screen structure C13 of the processing target, and obtains the best association method \hat{ }f^{m1, . . . , 2}_{k1, . . . , kn-1} (see (9) in FIG. 23).

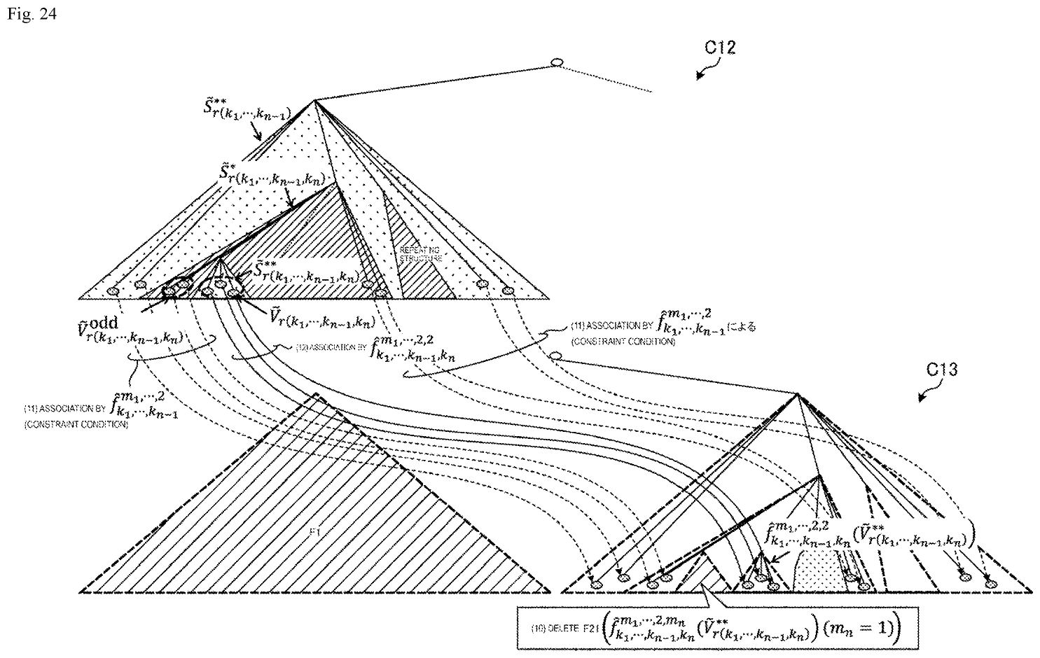

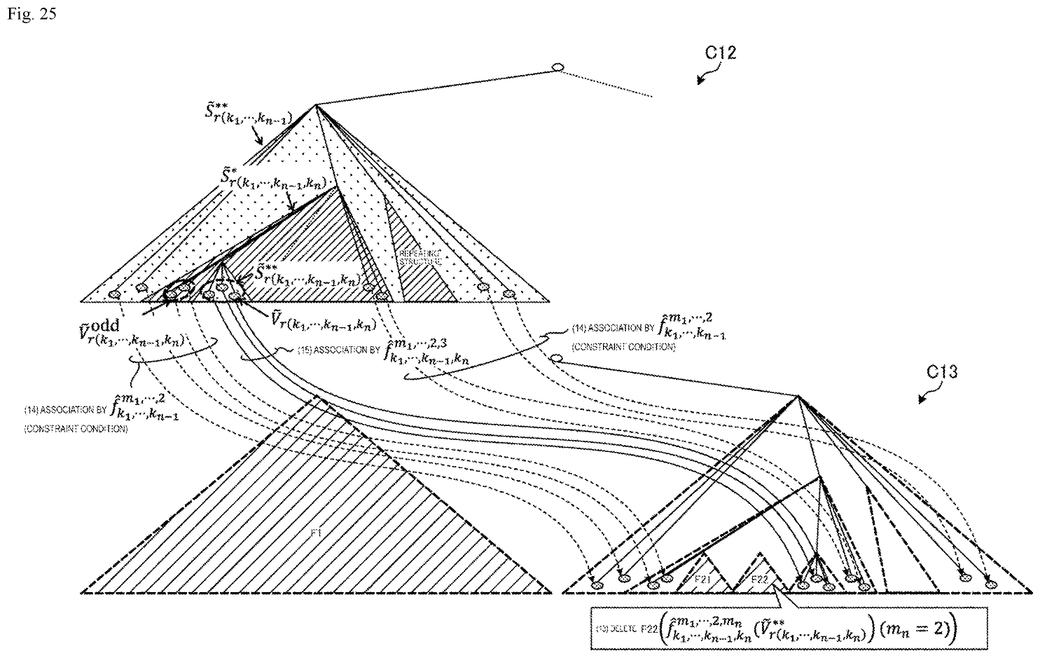

Subsequently, the screen configuration comparison unit 1314 performs similar processing to that for the first repeating unit in the second repeating unit in the screen structure of the processing target, which is equivalent to the repeating unit ˜S**_{r(k1, . . . , kn-1)} (see FIGS. 24 and 25. Because the repeating structure ˜S*_{r(k1, . . . , kn-1, kn)} does not have a repeating structure therein, the screen configuration comparison unit 1314 performs the processing for the repeating structure of the bottom layer in the second repeating unit, as illustrated in FIGS. 24 and 25. In addition, the screen configuration comparison unit 1314 enumerates the equivalents to screen components of the control target inside the second repeating unit.

The screen configuration comparison unit 1314 repeats the above process until Relationship (13) is obtained.

$$[ Math . 13 ]$$

$$\frac{\vert Def ( {\hat{f}}_{{k}_{1} , … , {k}_{n - 1}}^{{m}_{1} , … , {M}_{n - 1}} ) ⋂ {\tilde{V}}_{r ( {k}_{1} , … , {k}_{n - 1} )} \vert}{\vert {\tilde{V}}_{r ( {k}_{1} , … , {k}_{n - 1} )} \vert} < 1 ( Where {M}_{n - 1} \geq 2 ) \qquad ( 13 )$$

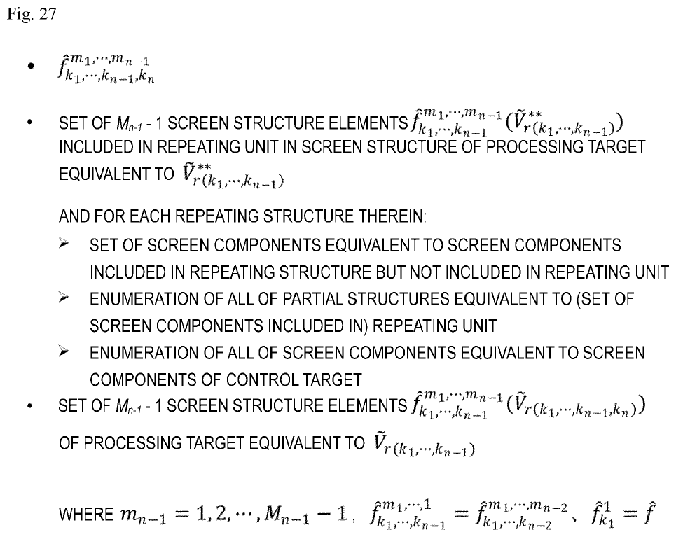

FIG. 27 is a diagram for explaining computation results acquired by the screen configuration comparison unit 1314. The screen configuration comparison unit 1314 repeats the above process until Relationship (13) is obtained, and obtains the results illustrated in FIG. 27.

### 10. Trimming Process of Sample Screen Data

Next, the trimming process of the sample screen data by the trimming unit 132 will be described. The identification apparatus 10 may use a screen structure of screen data acquired on a certain terminal at a certain time as is for the screen structure of the sample. The identification apparatus 10 may use a screen structure of the acquired screen data that has been trimmed in advance in step S1 of FIG. 12 (at the time of application of option 1-2). The identification apparatus 10 may trim the screen structure of the sample (step S5 in FIG. 12) by using a plurality of pieces of screen data acquired at different times and by different terminals and given the identification results, and use the screen structures in the subsequent identification processes (at the time of application of option 1-2). Note that a plurality of pieces of sample screen data are held in the identification information storage unit 123. The identification apparatus 10 independently trims the screen structures of these samples. Thus, in the following description, arbitrary one piece of sample screen data in the sample screen data will be described.

### 11. Pre-Trimming Process

First, the processing procedure of the pre-trimming process (step S1 in FIG. 12) (option 1-1) will be described.

The trimming unit 132 trims the screen structure of each sample held by the identification information storage unit 123 according to the neighborhood distance and the necessity of the descendant screen components specified in advance (option 1-1). However, in the pre-trimming process, the case where the screen structure is a directed tree is targeted.

In a case of performing trimming in advance, for the screen structure of the acquired screen data, the screen structure is trimmed such that the screen components of the control target and the ancestors and the neighbors thereof remain.

Note that same values specified in advance may be used for all of the screen structures of the sample and the screen components of the control target in the neighborhood distance and the necessity of the descendant screen components described below. The trimming unit 132 may use different values specified in advance for each sample screen data screen structure or each screen component of the control target (option 1-1-1). These values can be obtained by referring to the screen structure trimming individual configuration 123T of the identification information storage unit 123, or the neighborhood distance or the necessity of the descendant screen components of the attributes 123A of the screen components.

The screen components of the control target and the ancestors and the neighbors thereof are not limited to those specific to the screen structure of the sample and screen structures equivalent thereto, but all of them may also be included in other non-equivalent screen structures. In that case, even if the equivalent screen components can be identified in the screen structure equivalent to the screen structure of the sample only with the screen components that are truly control target in the program for the purpose of automation, assistance, or the like of terminal operations and the ancestors and the neighbors thereof, it may not be possible to identify whether the screen structure is equivalent to the screen structure of the sample similarly to before trimming. Thus, in this method, it is assumed that not only the screen components that are truly control target, but also the screen components of the screen structure of the sample and the screen components considered to be specific to the screen structures equivalent thereto are also specified as the screen components of the control target.

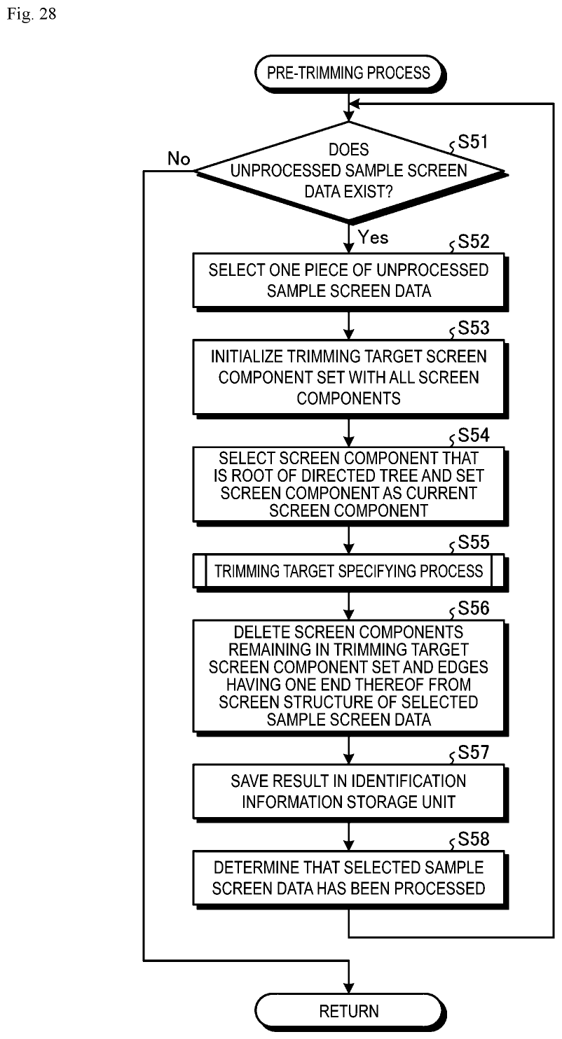

FIG. 28 is a flowchart illustrating a processing procedure of the pre-trimming process. As illustrated in FIG. 28, first, the trimming unit 132 determines whether sample screen data for which the trimming process has not been processed exists in the sample screen data held by the identification information storage unit 123 (step S51). In a case where unprocessed sample screen data does not exist (step S51: No), the trimming unit 132 ends the pre-trimming process.

On the other hand, in a case where unprocessed sample screen data exists (step S51: Yes), the trimming unit 132 selects one piece of unprocessed sample screen data (step S52). The trimming unit 132 initializes the trimming target screen component set with all screen components (step S53). In addition, the trimming unit 132 selects a screen component that is the root of the directed tree and determines the screen component as the current screen component (step S54).

The trimming unit 132 performs a trimming target specifying process for specifying the trimming target of screen components and the descendants thereof for the current screen component (step S55).

Subsequently, the trimming unit 132 deletes the screen components remaining in the trimming target screen component set and the edges having one end thereof from the screen structure of the selected sample (step S56). The trimming unit 132 saves the trimming result (sample screen data after trimming) in the identification information storage unit 123 (step S57). In addition, the trimming unit 132 determines that the selected sample screen data has been processed (step S58), and the process proceeds to step S51 in order to perform the trimming process for the next sample screen data.

11.1. Trimming Target Specifying Process

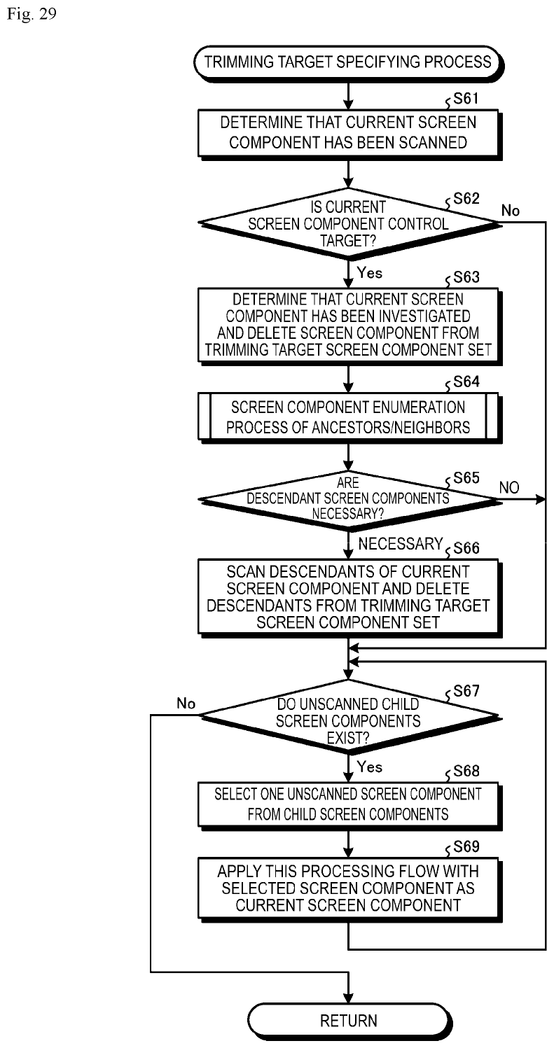

Next, the trimming target specifying process (step S55) illustrated in FIG. 28 will be described. FIG. 29 is a flowchart illustrating a processing procedure of the trimming target specifying process illustrated in FIG. 28.

As illustrated in FIG. 29, the trimming unit 132 determines that the current screen component has been scanned (step S61). In addition, the trimming unit 132 determines whether the current screen component is the control target (step S62).

In a case where the current screen component is the control target (step S62: Yes), the trimming unit 132 determines that the current screen component has been investigated and deletes the screen component from the trimming target screen component set (step S63). Subsequently, the trimming unit 132 performs a screen component enumeration process of ancestors/neighbors for enumerating the screen components of the ancestors and neighbors (step S64).

In addition, the trimming unit 132 determines the necessity of the descendant screen components (step S65). Here, the trimming unit 132 may use same values specified in advance for all of the screen structures of the sample and the screen components of the control target in the necessity of the descendant screen components. The trimming unit 132 may use different values specified in advance for each sample screen data screen structure or each screen component of the control target. These values can be obtained by referring to the screen structure trimming individual configuration 123T of the identification information storage unit 123 or the necessity of the descendant screen components of the attributes 123A of the screen components.

In a case where the necessity of the descendant screen components is “necessary” (step S65: necessary), the trimming unit 132 scans the descendants of the current screen component and deletes the descendants from the trimming target screen component set (step S66).

In a case where the current screen component is not the control target (step S62: No), in a case where the necessity of the descendant screen components is “No” (step S65: No), or after the process of step S66, the trimming unit 132 determines whether unscanned child screen components exist (step S67).

In a case where unscanned child screen components exist (step S67: Yes), the trimming unit 132 selects one unscanned screen component from the child screen components (step S68). In addition, the trimming unit 132 applies this processing flow with the selected screen component as a current screen component (step S69), and the process proceeds to step S67. In a case where unscanned child screen components do not exist (step S67: No), the trimming unit 132 ends the trimming target specifying process.

11.2. Screen Component Enumeration Process of Ancestors/Neighbors

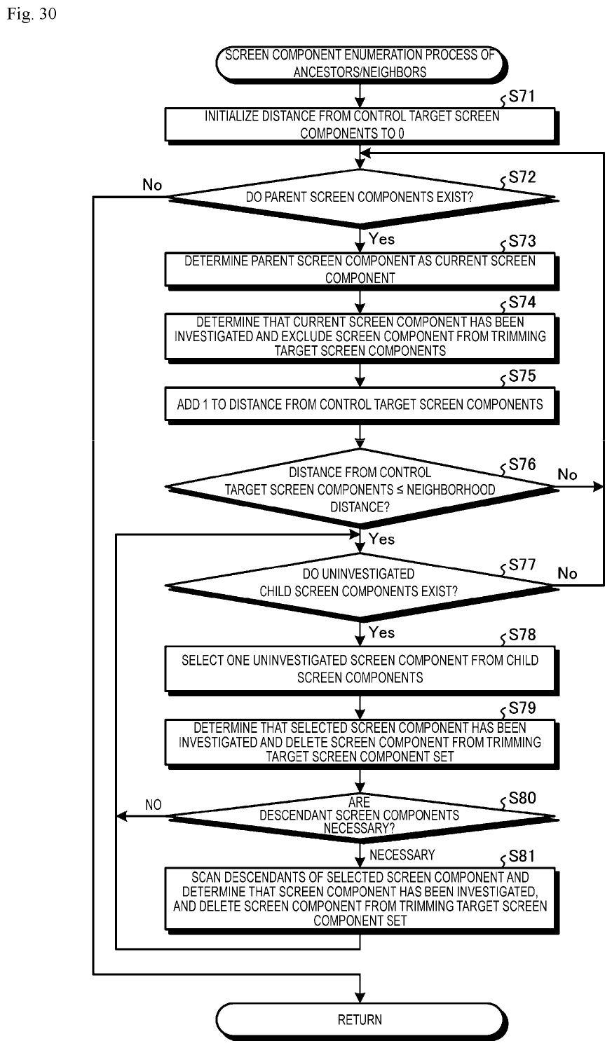

Next, the screen component enumeration process of ancestors/neighbors (step S64) illustrated in FIG. 29 will be described. FIG. 30 is a flowchart illustrating a processing procedure of the screen component enumeration process of ancestors/neighbors illustrated in FIG. 29.

As illustrated in FIG. 30, first, the trimming unit 132 initializes the distance from the control target screen components to 0 (step S71). Subsequently, the trimming unit 132 determines whether parent screen components exist (step S72). In a case where parent screen components do not exist (step S72: No), the trimming unit 132 ends the screen component enumeration process of ancestors/neighbors.

In a case where parent screen components exist (step S72: Yes), the trimming unit 132 determines a parent screen component as a current screen component (step S73). In addition, the trimming unit 132 determines that the current screen component has been investigated and also excludes the screen component from the trimming target screen components (step S74). The trimming unit 132 adds 1 to the distance from the control target screen components (step S75).

The trimming unit 132 compares the distance from the control target screen components and a predetermined neighborhood distance, and determines whether the distance from the control target screen components≤the neighborhood distance (step S76). Here, the trimming unit 132 may use same values specified in advance for all of the screen structures of the sample and the screen components of the control target as the neighborhood distance. The trimming unit 132 may use different values specified in advance for each sample screen data screen structure or each screen component of the control target. These values can be obtained by referring to the screen structure trimming individual configuration 123T of the identification information storage unit 123 or the neighborhood distance of the attributes 123A of the screen components.

In a case where not the distance from the control target screen components≤the neighborhood distance (step S76: No), that is, in a case where the distance from the control target screen components>the neighborhood distance, the trimming unit 132 proceeds to the process of step S72.

On the other hand, in a case where the distance from the control target screen components≤the neighborhood distance (step S76: Yes), the trimming unit 132 determines whether uninvestigated child screen components exist (step S77). In a case where uninvestigated child screen components do not exist (step S77: No), the trimming unit 132 proceeds to the process of step S72.

In a case where uninvestigated child screen components exist (step S77: Yes), the trimming unit 132 selects one uninvestigated screen component from the child screen components (step S78). In addition, the trimming unit 132 determines that the selected screen component has been investigated and deletes the screen component from the trimming target screen component set (step S79).

Subsequently, the trimming unit 132 determines the necessity of the descendant screen components (step S80). In a case where the necessity of the descendant screen components is “necessary” (step S80: necessary), the trimming unit 132 scans the descendants of the selected screen component and determines that the screen component has been investigated, and deletes the screen component from the trimming target screen component set (step S81). In a case where the necessity of the descendant screen components is “No” (step S80: No), or after the process of step S81, the trimming unit 132 proceeds to the process of step S77.

### 12. Post-Identification Trimming Process

Next, the post-identification trimming process (step S5) (option 1-2) illustrated in FIG. 12 will be described.

The screen components of the control target are not limited to those specific to the screen structure of the sample and screen data equivalent thereto. Thus, in this method, screen components that can be trimmed are obtained so as to satisfy both the first and second conditions below.

The first trimming condition is that the control target screen components in the screen structure of the sample are not confused with other screen structure elements included in the screen structure of the sample itself. The second trimming condition is that the determination of the equivalence with the screen structure of the sample does not change before and after trimming.

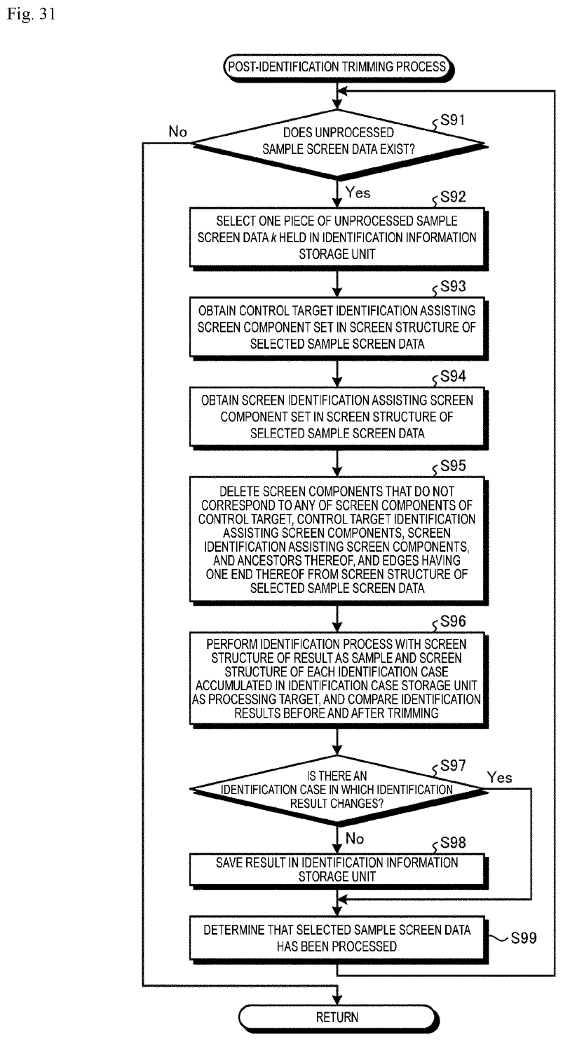

Next, a processing procedure of the post-identification trimming process will be described. FIG. 31 is a flowchart illustrating a processing procedure of the post-identification trimming process illustrated in FIG. 12. However, in the post-identification trimming process, the case where the screen structure is a directed order tree is targeted.

As illustrated in FIG. 31, the trimming unit 132 determines whether unprocessed sample screen data exists in the identification information storage unit 123 (step S91). In a case where unprocessed sample screen data does not exist in the identification information storage unit 123 (step S91: No), the trimming unit 132 ends the post-identification trimming process.

In a case where unprocessed sample screen data exists in the identification information storage unit 123 (step S91: Yes), the trimming unit 132 selects one piece of unprocessed sample screen data k held in the identification information storage unit 123 (step S92).

Subsequently, the trimming unit 132 obtains a control target identification assisting screen component set in the screen structure of the selected sample (step S93). In addition, the trimming unit 132 obtains a screen identification assisting screen component set in the screen structure of the selected sample (step S94).

The trimming unit 132 deletes screen components that do not correspond to any of the screen components of the control target, the control target identification assisting screen components, the screen identification assisting screen components, and the ancestors thereof, and the edges having one end thereof from the screen structure of the selected sample (step S95).

The trimming unit 132 performs the identification process with the screen structure of the trimming result as a sample and the screen structure of each identification case accumulated in the identification case storage unit 126 as a processing target, and compares the identification results before and after trimming (step S96). The trimming unit 132 determines whether there is an identification case in which the identification result changes before and after trimming (step S97).

In a case where the identification result does not change before and after trimming in any of the identification cases (step S97: No), the trimming result is saved in the identification information storage unit 123 (step S98). In a case where the identification result changes before and after trimming (step S97: Yes), or after the process of step S98 is completed, the trimming unit 132 determines that the selected sample screen data has been processed (step S99). In addition, the process returns to step S91, and the trimming unit 132 determines whether there is next sample screen data.

12.1. First Trimming Condition

The range in which screen components need to be set so as not be confused depends on whether there are screen components included in the repeating structure among the screen components of the control target. Thus, in the following, the processing method will be described step by step with cases classified according to the presence or absence of repeating structures in the screen structure and the presence or absence of nesting thereof. Ultimately, by performing the processing of the “general form” in any cases, screen components of neighbors necessary for identification “control target identification assisting screen components”, which are necessary for satisfying the first trimming condition, are obtained.

12.1.1. Basic Form (No Repeating Structure)

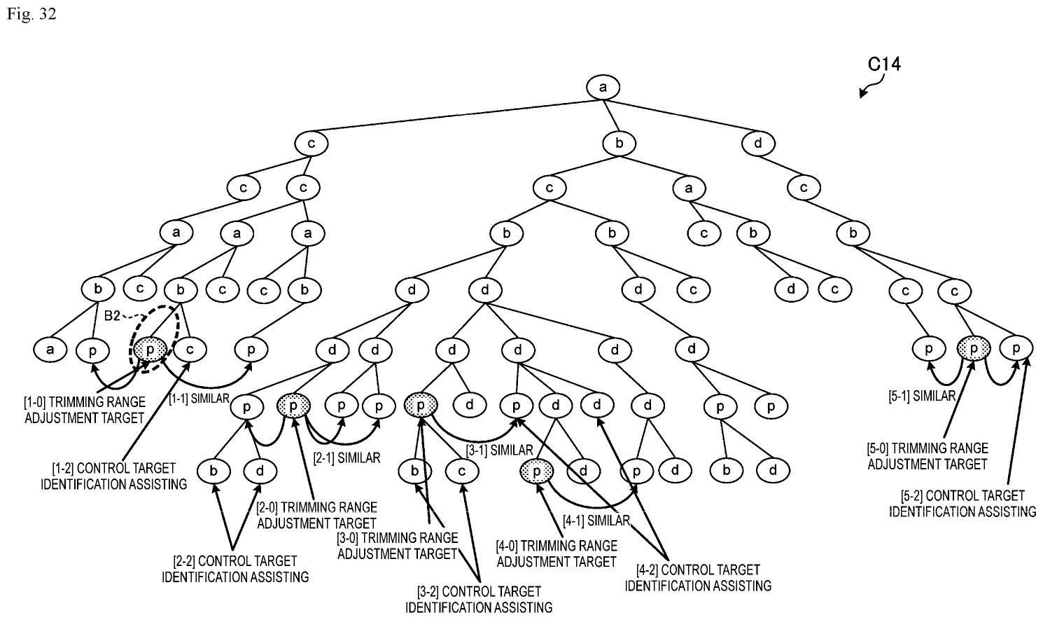

First, the process of the basic form without repeating structures will be described. FIG. 32 is a diagram for explaining a process for obtaining control target identification assisting screen components. The trimming unit 132 performs the following first and second processes with sequentially determining each screen component of the control target among the elements of the directed order tree C14 as a trimming range adjustment target (for example, [1-0] to [5-0]trimming range adjustment target), to obtain control target identification assisting screen components (for example, [1-2] to [5-2] control target identification assisting) so as to satisfy the first trimming condition.

As the first process, the trimming unit 132 extracts the screen components (hereinafter referred to as “similar screen components”) (see [1-1] to [5-1] similar in FIG. 32) that cannot be distinguished and are determined as equivalent only by considering the ancestors, the descendants, and other screen components of the control target from the screen structure before trimming.

As the second process, the trimming unit 132 compares a screen structure (hereinafter referred to as a “trimming range adjustment target screen structure”) that consists of the screen components of the trimming range adjustment target, and the ancestors, the descendants, and the neighbors thereof, with a screen structure (hereinafter referred to as a “similar screen structure”) that consists of each similar screen component, and the ancestors, the descendants and the neighbors thereof, in the screen structure before trimming, while gradually increasing the neighborhood distance, to obtain screen components (hereinafter referred to as “control target identification assisting screen components”) (for example, [1-2] to [5-2] control target identification assisting) that can be used to distinguish the screen components of the trimming range adjustment target from the similar screen components.

In the descriptions of the first process and the second process, among the screen components of the control target, the set of screen components of the trimming range adjustment target is defined as Uᵣ (⊆˜Vᵣ), and the set of screen components other than the trimming range adjustment target is defined as ⁻Uᵣ (⊆˜Vᵣ). In the basic form, |Uᵣ|=1 is true, but in the extended form described later, there is a case of |Uᵣ|≥1.

12.1.1.1. First Process

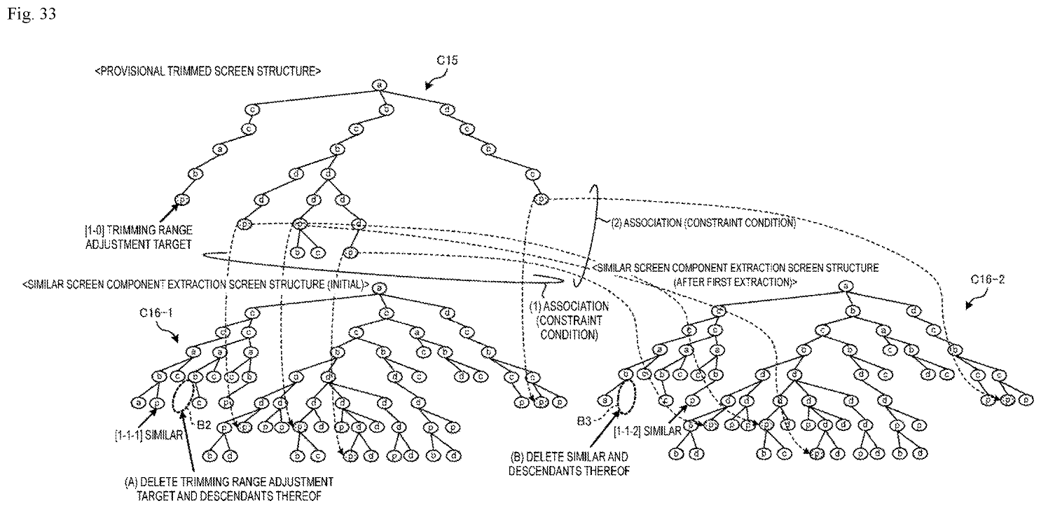

FIG. 33 is a diagram illustrating a process example for obtaining a similar screen configuration. FIG. 33 illustrates a provisional trimmed screen structure C15, a similar screen component extraction screen structure (initial) C16-1, and a similar screen component extraction screen structure (after the first extraction) C16-2.

In the first process, first, the provisional trimmed screen structure C15 and the similar screen component extraction screen structure C16-1 are created from the screen structure before trimming.

The provisional trimmed screen structure C15 is a screen structure that consists of all of the screen components of the control target and the ancestors and the descendants thereof. The similar screen component extraction screen structure C16-1 is a screen structure in which the screen components of the trimming range adjustment target and the descendants (for example, B2 in FIG. 32) are deleted from the screen structure before trimming (see (A) in FIG. 33).

The trimming unit 132 uses the provisional trimmed screen structure C15 as a sample, and the similar screen component extraction screen structure C16-1 as a processing target, to obtain the first best association method \hat{ }g¹ according to the following constraint condition and the evaluation method.

The constraint condition is a condition that all screen components of the control target other than the trimming range adjustment target are associated with themselves (see (1) in FIG. 33). As the evaluation method, an evaluation method of evaluating based on the magnitude of the number of associated screen components is adopted.

As a result, in a case where (all of) the screen components of the trimming range adjustment target in the provisional trimmed screen structure C15 (for example, [1-0] trimming range adjustment target in FIG. 33) are associated with any screen component in the similar screen component extraction screen structure C16-1 (Uᵣ ⊆Def(\hat{ }g¹)), the trimming unit 132 records the association method. Then, the trimming unit 132 deletes the similar screen components (screen components included in \hat{ }g¹(Uᵣ)) (for example, [1-1-1] similar in FIG. 33) and the descendants B3 from the similar screen component extraction screen structure C16-1 (see (B) in FIG. 33) and obtains the next similar screen component extraction screen structure C16-2, to obtain the second best association method \hat{ }g² according to the same constraint condition and the evaluation method again.

In a case where (all of) the screen components of the trimming range adjustment target in the provisional trimmed screen structure C15 (for example, [1-0] trimming range adjustment target in FIG. 33) are associated with any screen component in the similar screen component extraction screen structure C16-2 (Uᵣ ⊆Def(\hat{ }g²)) after deleting the similar screen components and the descendants thereof B3, the trimming unit 132 records the association method. Then, the trimming unit 132 deletes the similar screen components (screen components included in \hat{ }g²(Uᵣ)) (for example, [1-1-2] similar in FIG. 33) and the descendants from the similar screen component extraction screen structure C16-2 and obtains the next similar screen component extraction screen structure C16-3, to obtain the third best association method \hat{ }g³ according to the same constraint condition and the evaluation method again.

The trimming unit 132 performs these processes until there is no screen component associated with the (any) screen components of the trimming range adjustment target. Note that, in the case of the relationship indicated in Relationship (14), no similar screen components do not exist, and thus the trimming unit 132 does not perform the second process, and obtains an empty set of control target identification assisting screen components.

[Math. 14]

Uᵣ [symbol] Def(ĝ¹) (14)

12.1.1.2. Second Process

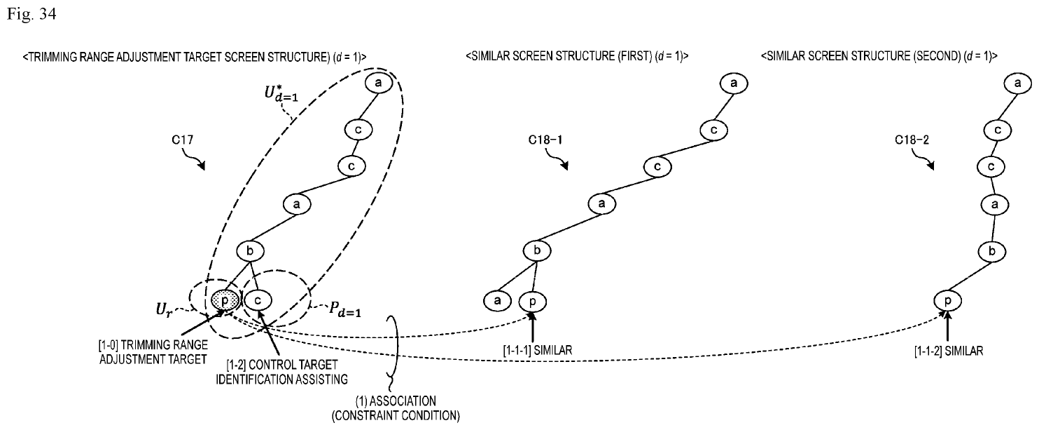

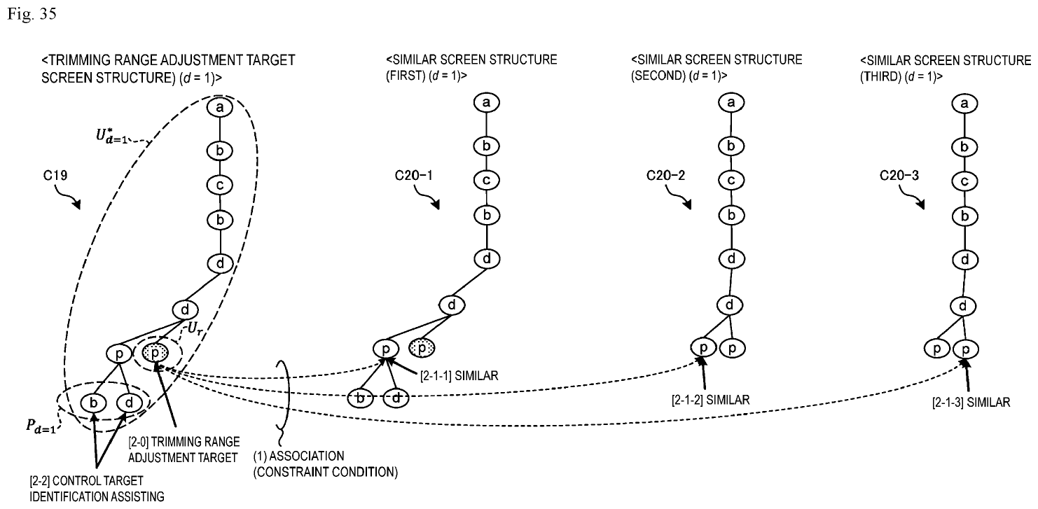

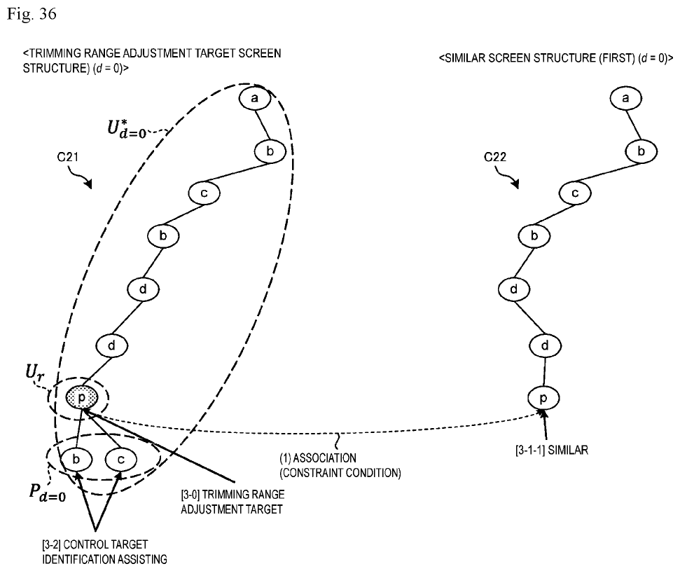

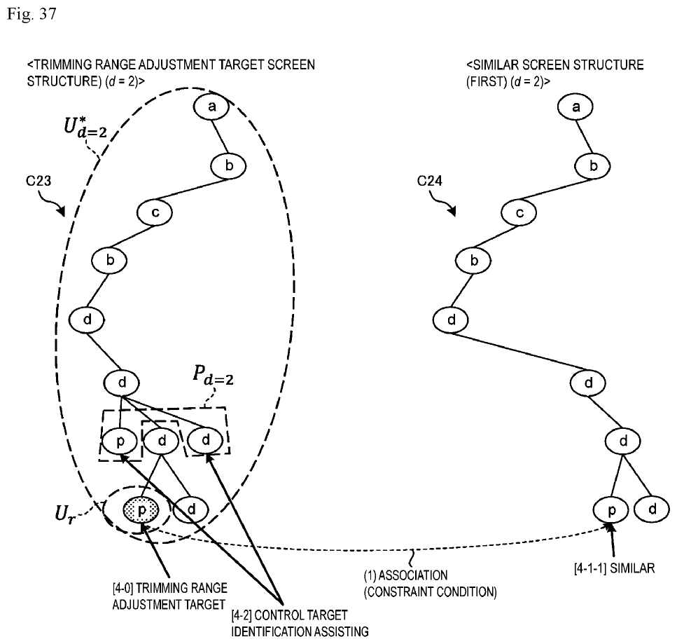

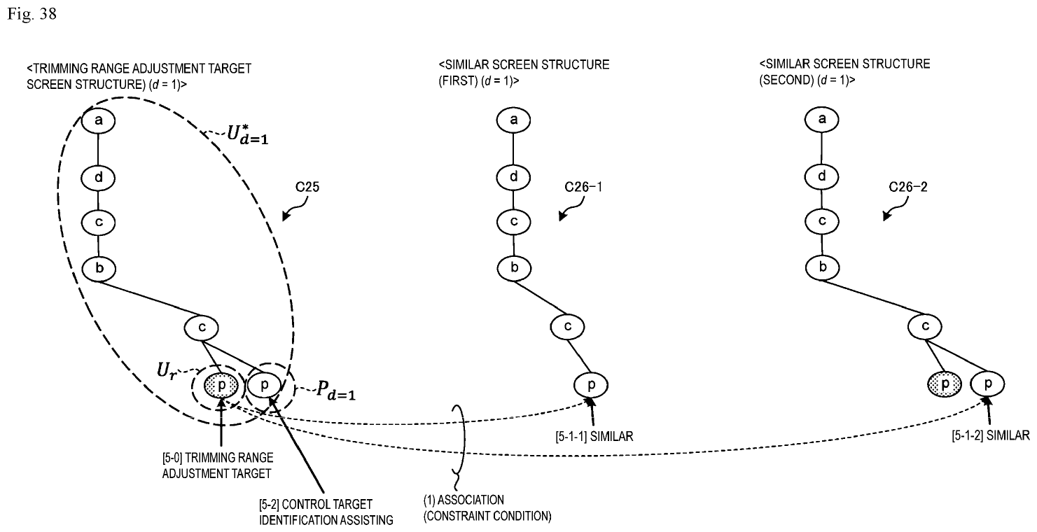

Next, the second process will be described with reference to FIGS. 34 to 38. FIGS. 34 to 38 are diagrams illustrating an example of a process for obtaining control target identification assisting screen components.

In the second process, first, in the screen structure before trimming, the neighborhood distance is set to 0, and the screen structure is trimmed such that the screen components of the trimming range adjustment target, and the ancestors, the descendants, and the neighbors thereof remain, to create the trimming range adjustment target screen structure.

Hereinafter, in a case where the neighborhood distance is d, the set of screen components included in the trimming range adjustment target screen structure is referred to as U*_{d}. The trimming range adjustment target screen structures C17, C19, C21, C23, and C25 illustrated in FIGS. 34 to 38 are examples of trimming range adjustment target screen structures.

Similarly, in the screen structure before trimming, the trimming unit 132 trims the screen structure such that the similar screen components (all of the screen components included in \hat{ }g^{m}(Uᵣ)), and the ancestors, the descendants, and the neighbors thereof remain for each association method \hat{ }g¹, \hat{ }g², . . . , \hat{ }g^{m}, . . . obtained in the first process, to create the first, second, . . . , m-th, . . . similar screen structures. For example, the trimming unit 132 creates similar screen structures C18-1, C18-2, C20-1 to C20-3, C22, C24, C26-1, and C26-2.

After that, the trimming unit 132 performs comparison with the trimming range adjustment target screen structure as a sample and each similar screen structure as a processing target, to obtain the best association method \hat{ }h^{m} according to the following constraint condition and the evaluation method.

The constraint condition is that all of the screen components of the control target of the trimming range adjustment target are associated with the similar screen components extracted in the first process (see, for example, (1) in FIG. 34). As the evaluation method, an evaluation method of evaluating based on the magnitude of the number of associated screen components is adopted. The trimming range adjustment target is, for example, [1-0], [2-0], [3-0], [4-0], and [5-0] trimming range adjustment target illustrated in FIGS. 34 to 38. The similar screen components are, for example, [1-1-1], [1-1-2], [2-1-1] to [2-1-3], [3-1-1], [4-1-1], [5-1-1], and [5-1-2] illustrated in FIGS. 34 to 38.

Note that the first time when the neighborhood distance is set to 0 gives the portion related to the trimming range adjustment target screen structure among the best association methods obtained in the first process, and thus the result of the first process may be diverted.

The trimming unit 132 obtains a set P_{d} (see Relationship (15)) of screen components that cannot be associated with any screen component in any similar screen structure by comparison with all similar screen structures.

[Math. 15]

P_{d}≡{v∈U*_{d}|∀m,v∉Def(ĥ^{m})} (15)

Further, the trimming unit 132 determines whether the screen components can be associated with each of the siblings (however except for the screen components of the trimming range adjustment target and the ancestors thereof) in the trimming range adjustment target screen structure for each screen component v included in P_{d}, and adds the screen components determined as “association impossible” with all siblings as the result to the set Q of the control target identification assisting screen components. The control target identification assisting screen components are, for example, [1-2], [2-2], [3-2], [4-2], and [5-2] control target identification assisting illustrated in FIGS. 34 to 38.

The trimming unit 132 repeats similar processing while increasing the neighborhood distance d until one or more control target identification assisting screen components are found, or until the neighborhood distance d is equal to or greater than the depth d_{Ur} from the root screen component of the screen structure before trimming to the screen components of the trimming range adjustment target, and the entire screen structure before trimming is included in the neighborhood.

Note that, in a case where the neighborhood distance d is d_{Ur} before one or more control target identification assisting screen components are found, due to the existence of repeating structures that are not specified in advance, the trimming unit 132 cannot identify the screen components of the trimming range adjustment target, even if the screen components of the ancestors, the descendants, and the neighbors are taken into consideration, and thus notifies the user of the identification apparatus 10 to that effect, and interrupts the trimming of the screen structure of the sample.

12.1.2. Extended Form

Next, an extended form in which an arbitrary number of repeating structures having a maximum of one layer are included will be described.

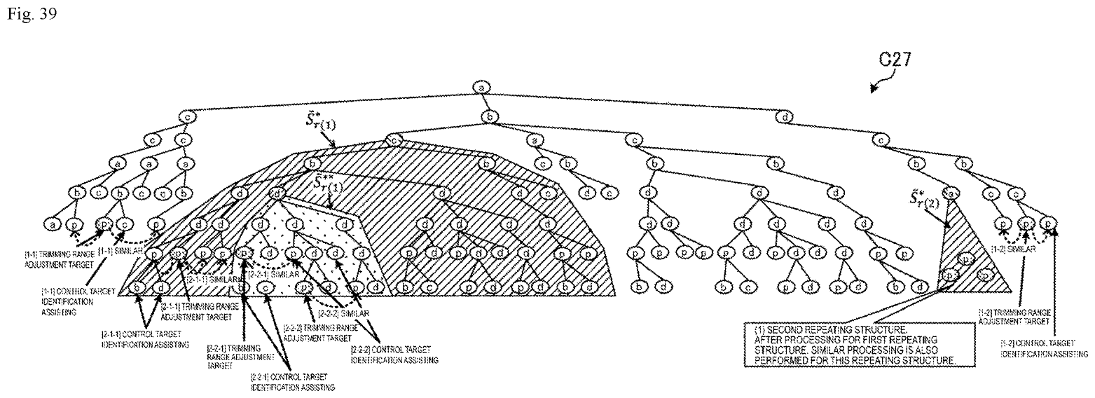

FIGS. 39 to 41 are diagrams for explaining a process for obtaining control target identification assisting screen components in a case where the repeating structure has one layer. In the screen structure C27 in FIG. 39, the trimming unit 132 performs the process of the basic form for each screen component vᵢ∈˜Vᵣ₍₀₎ (see [1-1] and [1-2] trimming range adjustment target in FIG. 39) of the control target that is not included in the repeating structure, to obtain a set Ω_{0, i} of control target identification assisting screen components thereof (see [1-1] and [1-2] control target identification assisting in FIG. 39). Note that, in the following, the first repeating structure ˜S*ᵣ₍₁₎ will be mainly described, but after the processing for the first repeating structure ˜S*ᵣ₍₁₎, similar processing is performed for the second repeating structure ˜S*ᵣ₍₂₎ (see (1) in FIG. 39). In the example illustrated in FIG. 39, the number of repeating structures is two, but even in a case where there are three or more repeating structures, similar processing is sequentially performed on the second and subsequent repeating structures.

In the k-th repeating structure ˜S*ᵣ₍ₖ₎=(˜V*ᵣ₍ₖ₎, ˜E*ᵣ₍ₖ₎), the screen components ˜V^{odd}ᵣ₍ₖ₎ that are included in the repeating structure but not included in the repeating unit are first set not to be confused with other screen components inside the repeating structure. Thus, in the screen structure before trimming, the trimming unit 132 considers a subtree corresponding to the repeating structure, and performs the process of the basic form with sequentially determining only the screen components included in ˜V^{odd}ᵣ₍ₖ₎ as a trimming range adjustment target (see [2-1-1] trimming range adjustment target in FIG. 39), to obtain the set Ωⁱⁿₖ of the control target identification assisting screen components for ˜Vᵣ₍ₖ₎ ∪˜V^{odd}ᵣ₍ₖ₎ (see [2-1-1] control target identification assisting in FIG. 39).

The screen components ˜Vᵣ₍ₖ₎ (see [2-2-1] and [2-2-2] trimming adjustment range target in FIG. 39) of the control target that are included in the repeating unit ˜S**ᵣ₍ₖ₎=(˜V**ᵣ₍ₖ₎, ˜E**ᵣ₍ₖ₎), which is a partial structure of the repeating structure ˜S*ᵣ₍ₖ₎, are first set not to be confused with other screen components inside the repeating unit. Thus, in the screen structure before trimming, the trimming unit 132 considers a subtree corresponding to the repeating unit, and performs the basic form process, to obtain the set Ωⁱⁿₖ of the control target identification assisting screen components for ˜Vᵣ₍ₖ₎ ∪˜V^{odd}ᵣ₍ₖ₎ (see [2-2-1] and [2-2-2] control target identification assisting in FIG. 39).

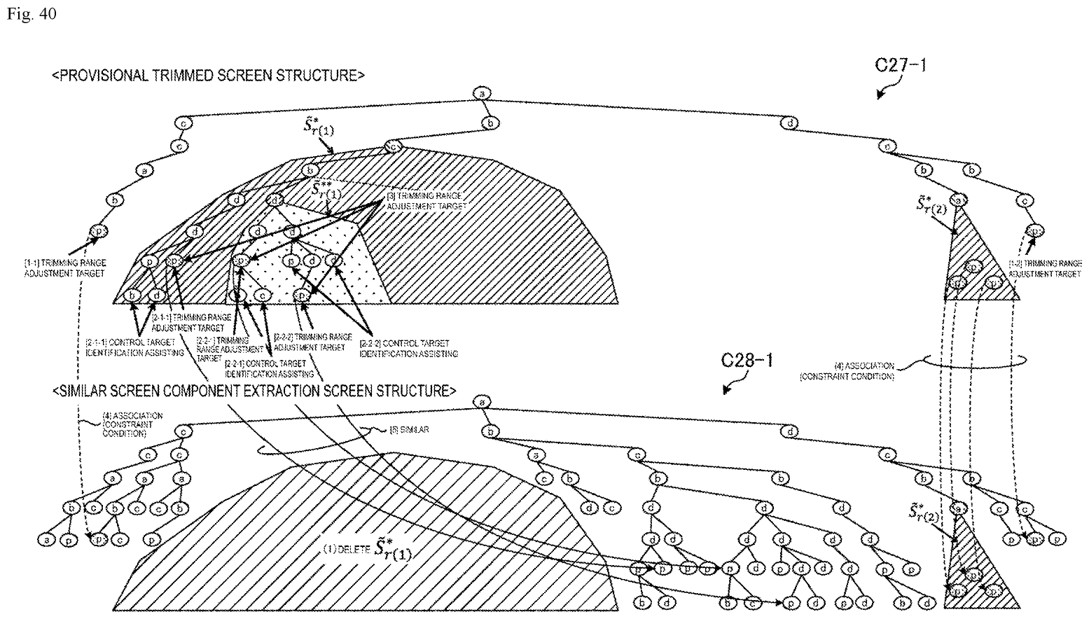

Next, in the screen structure before trimming, the screen components existing outside the k-th repeating structure and the screen components included in ˜Vᵣ₍ₖ₎ ∪˜V^{odd}ᵣ₍ₖ₎ are set not to be confused with each other. Thus, in the process of the basic form, the trimming unit 132 performs the first and second processes with ˜Vᵣ₍ₖ₎∪˜V^{odd}ᵣ₍ₖ₎ as a set Uᵣ of screen components of the trimming range adjustment target (see [3] trimming range adjustment target in FIG. 40).

However, the provisional trimmed screen structure and the similar screen component extraction screen structure in the first process are individually set as follows (see [4] association (constraint condition), and [5] similar in FIG. 40).

The provisional trimmed screen structure (for example, C27-1 in FIG. 40) is a screen structure that consists of only all of the screen components of the control target that are not included in ˜Vᵣ₍ₖ₎∪˜V^{odd}ᵣ₍ₖ₎, and the ancestors and the descendants thereof, and the screen components of the control target that are included in ˜Vᵣ₍ₖ₎∪˜V^{odd}ᵣ₍ₖ₎, and the control target identification assisting screen components thereof, and the ancestors thereof.

The similar screen component extraction screen structure (for example, C28-1 in FIG. 40) is a screen structure in which the subtree ˜S*ᵣ₍ₖ₎ corresponding to the k-th repeating structure is deleted in advance from the screen structure before trimming (see (1) in FIG. 40).

In the second process, the trimming range adjustment target screen structure and the m-th similar screen structure are individually set as follows.

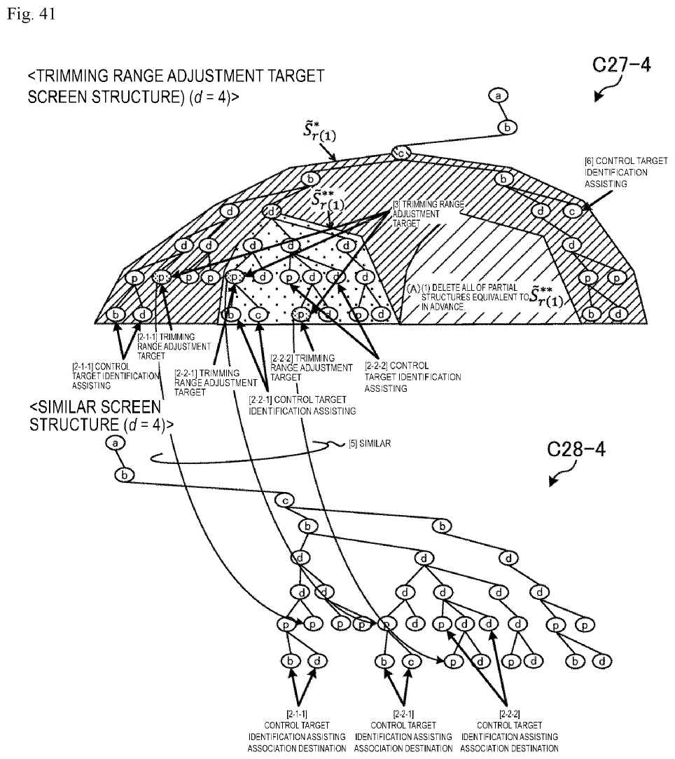

For the trimming range adjustment target screen structure (for example, C27-4 in FIG. 41), in the repeating structure ˜S*ᵣ₍ₖ₎ in the screen structure before trimming, all of the partial structures equivalent to the repeating unit ˜S**ᵣ₍ₖ₎ are enumerated, and the second and subsequent partial structures are deleted (see (A) in FIG. 41). For this, the identification process of the extended form may be performed with regarding the screen structure of the sample before trimming itself as the screen structure of the processing target. The trimming range adjustment target screen structure is created by the second process with the screen structure obtained as the result as a pseudo screen structure before trimming. However, the control target identification assisting screen components (for example, [2-1-1], [2-2-1], and [2-2-2] control target identification assisting in FIG. 41) for ˜Vᵣ₍ₖ₎∪˜V^{odd}ᵣ₍ₖ₎ and the ancestors thereof are always included.

For the m-th similar screen structure (for example, C28-4 in FIG. 41), by the association method \hat{ }g^{m}, the screen components (for example, [2-1-1], [2-2-1], and [2-2-2] control target identification assisting association destination in FIG. 41) associated with the control target identification assisting screen components (for example, [2-1-1], [2-2-1], and [2-2-2] control target identification assisting in FIG. 41) for ˜Vᵣ₍ₖ₎∪˜V^{odd}ᵣ₍ₖ₎ and the ancestors thereof are always included.

That is, the trimming adjustment target screen structure (for example, C27-1 in FIG. 41) always includes the screen components included in the set Ωⁱⁿₖ and the ancestors thereof. In addition, the m-th similar screen structure (for example, C28-1 in FIG. 41) always includes screen components included in \hat{ }g^{m} (Ωⁱⁿₖ) and the ancestors thereof. The set of the control target identification assisting screen components obtained by performing the second process is referred to as Ω^{out}ₖ (see, for example, [6] control target identification assisting in FIG. 41).

Ultimately, the set Ωk of the control target identification assisting screen components necessary to avoid being confused with other screen structure elements, both inside the repeating structure or the repeating unit and outside the repeating structure, that is, in the entire screen structure before trimming, is obtained by Relationship (16) below.

[Math. 16]

Ωₖ=Ωₖⁱⁿ∪Ωₖ^{out} (16)

Note that it is assumed that the base point of the repeating structure is specified in advance in the screen structure of the sample, but in a case where the screen components included in ˜V^{odd}ᵣ₍ₖ₎ can be treated as screen components outside the repeating structure and ˜V^{odd}ᵣ₍ₖ₎ can be an empty set, the trimming unit 132 may automatically estimate the base point by the following method.

First, the trimming unit 132 determines the parent of the screen components corresponding to the repeating unit as the base point of the repeating structure. Alternatively, the trimming unit 132 obtains the control target identification assisting screen components (Ωⁱⁿₖ) necessary to prevent the screen components (˜Vᵣ₍ₖ₎) of the control target from being confused with other screen components inside the repeating unit. Then, the trimming unit 132 enumerates partial structures of other repeating units that are equivalent to the partial structures of the repeating unit in the screen structure before trimming by using the control target identification assisting screen components, and determines a screen component of an ancestor common to the partial structures as the base point of the repeating structure.

However, the search range for enumeration is the portion sandwiched between the following two screen components. The first screen component is the screen component located on the rightmost side of the control target screen components located on the left side of the leftmost screen component included in ˜Vᵣ₍ₖ₎. The second screen component is the screen component located on the leftmost side of the control target screen components located on the right side of the rightmost screen component included in ˜Vᵣ₍ₖ₎.

12.1.3. General Form

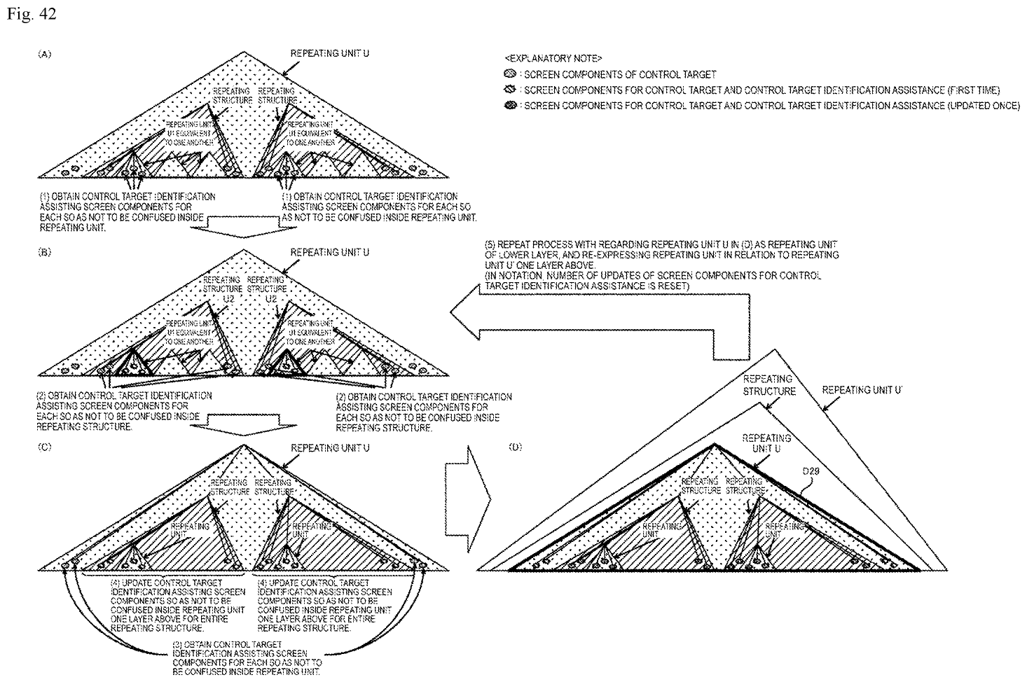

Next, a general form in which an arbitrary number of repeating structures with an arbitrary number of layers nested are included will be described. FIG. 42 is a diagram for explaining a process for obtaining control target identification assisting screen components in a case where an arbitrary number of repeating structures with an arbitrary number of layers nested are included.

As illustrated in FIG. 42, for each repeating structure and repeating unit U of each layer, the trimming unit 132 sequentially performs the process of the extended form, starting from the lower layer on the inside, that is, in a directed tree, a repeating structure having a deep depth from the root screen component to the screen components corresponding to the repeating structure (for example, the repeating structure U2), with regarding the screen structure of the repeating unit (for example, the repeating unit U) of the layer one layer above on the outside including the repeating structure as a screen structure of the sample.

For example, as illustrated in (A) of FIG. 42, the trimming unit 132 obtains the control target identification assisting image components for each of the screen components of the control target so as not to be confused inside the repeating unit (see (1) in FIG. 42).

As illustrated in (B) of FIG. 42, the trimming unit 132 obtains the control target identification assisting image components for each of the screen components of the control target that are included in the repeating structure U2 so as not to be confused inside the repeating structure (see (2) in FIG. 42). In addition, for each of the screen components of the control target that are included in the repeating unit one layer above but not included in the repeating structure U2, and the screen components included in the repeating structure U2, the trimming unit 132 updates the control target identification assisting screen components so as not to be confused inside the repeating unit one layer above (see (3) and (4) in FIG. 42). The trimming unit 132 repeats the process with regarding the repeating unit U in (D) of FIG. 42 as the repeating unit of the lower layer, and re-expressing the repeating unit in relation to the repeating unit U′ one layer above (that is, regarding the repeating unit U in (D) of FIG. 42 as the repeating unit U1 in (B) of FIG. 42, and regarding the repeating unit U′ in (D) of FIG. 42 as the repeating unit U in (B) of FIG. 42). Note that, in the notation, the number of updates of the assisting screen components for each control target is reset (see (5) in FIG. 42). In addition, the trimming unit 132 performs the process for obtaining the control target identification assisting image components for each of the screen components of the control target that are included in the repeating structure U2 so as not to be confused inside the repeating structure.

As a result, the trimming unit 132 obtains the set of control target identification assisting screen components necessary for not being confused with other screen structure elements of the control target, inside the repeating structure and the repeating unit of the bottom layer, inside the repeating structure and the repeating unit one layer above, inside the repeating structure and the repeating unit further one layer above, . . . , inside the repeating structure and the repeating unit of the top layer, and in the whole screen structure of the sample.

12.2. Second Trimming Condition

Next, the second trimming condition will be described. In the screen structure of the sample, there are screen components that do not affect the identification results and screen components that affect the identification results.

Even if the screen structures of the sample and the processing target are equivalent, in a case where whether a screen component v∈Vᵣ of the sample is associated with a screen component of the processing target according to the best association method \hat{ }f, that is, whether v∈Def(\hat{ }f) depends on the screen structure of the processing target, it is considered that the screen component v of the sample does not affect the determination of the equivalence. Similarly, even if the screen structures of the sample and the processing target are not equivalent, depending on the screen structure of the processing target, in a case where a screen componentv∈Vᵣ of the sample may be associated with a screen component of the processing target according to the best association method \hat{ }f, that is, in a case where v∈Def(\hat{ }f) may be true, it is considered that the screen component v of the sample does not affect the determination of equivalence.

On the other hand, if v∈Def(\hat{ }f) is always true in a case where the screen structures of the sample and the processing target are equivalent, and the relationship indicated in Relationship (17) is always true in case where the screen structures of the sample and the processing target are not equivalent, it is considered that the screen component v of the sample affects the determination of the equivalence.

[Math. 17]

v∉Def(\hat{f}) (7)

Within the range of cases accumulated in the identification case storage unit 126, v∈Def(\hat{ }f) is a necessary and sufficient condition for the equivalence of the screen structures.

Thus, in the present embodiment, for the identification cases related to arbitrary one piece of sample screen data accumulated in the identification case storage unit 126, a set of cases that are identified as equivalent is defined as C_{eq}, a set of cases that are not identified as equivalent is defined as C_{neq}. and a best association method in a case c is defined as \hat{ }f. The trimming unit 132 trims other screen components, leaving the screen component v of the sample and the ancestors thereof included in the set Qᵣ defined in Relationships (18) to (20).

[Math. 18]

Qᵣ⁺≡{v|c∈C_{eq}⇒v∈Def(\hat{f}^{c})} (18)

[Math. 19]

Qᵣ⁻≡{v|c∈C_{neq}⇒v∉Def(\hat{f}^{c})} (19)

[Math. 20]

Qᵣ≡Qᵣ⁺∩Qᵣ⁻ (20)

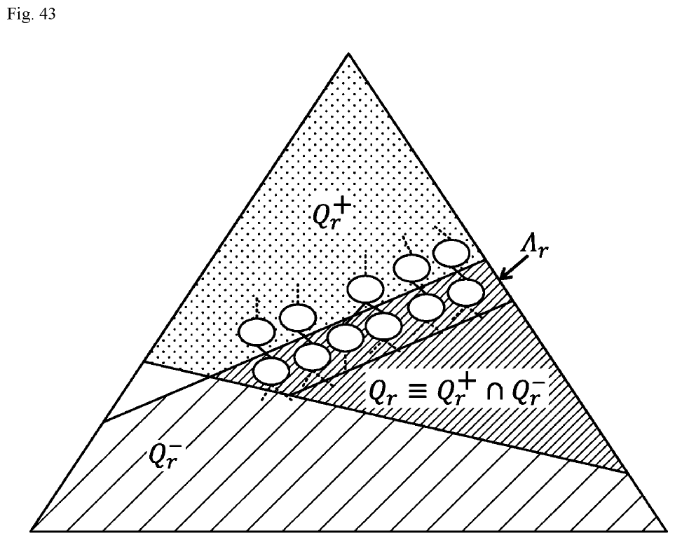

FIG. 43 is a diagram schematically illustrating common portions and non-common portions to an equivalent or non-equivalent screen structure. FIG. 43 conceptually illustrates the sets Qᵣ, Q⁺ᵣ, and Q⁻ᵣ and the set Λᵣ described later.

Further, in the screen structure after the trimming described above, when a screen component vᵢ is an ancestor of a screen component vⱼ and the screen component vᵢ is included in the set Qᵣ, the screen component vⱼ is always included in the set Qᵣ within the range of the identification cases accumulated in the identification case storage unit 126. This is due to the following reasons. Because vᵢ∈Q⁻ᵣ, all of the descendant elements thereof including the screen component vⱼ are included in the set Q⁻ᵣ. In addition, because a screen component which is a descendant of the screen component vⱼ and is a leaf in the tree structure after the trimming described above is included in the set Qᵣ, the screen component is also included in the set Q⁺ᵣ, and all of the ancestor elements thereof, including the screen component vⱼ, are elements of the set Q⁺ᵣ.

Thus, if vᵢ∈Def(\hat{ }f), the screen structures are equivalent. At this time, if vⱼ∈(Uᵣ ⊆) Def(\hat{ }f), and Relationship (21) is conversely true, the screen structures are not equivalent. At this time, because Relationship (22) is also self-evident, it is considered that the screen component vⱼ does not affect the determination of the equivalence under the condition that the equivalence determination is performed based on the screen component vᵢ.

[Math. 21]

vᵢ∉Def(\hat{f}) (21)

[Math. 22]

vⱼ∈Def(\hat{f}) (22)

Thus, in the present embodiment, as Λᵣ defined by Relationship (23), a set of screen identification assisting screen components, which are necessary so that the determination of the equivalence with the screen structure of the sample does not change before and after trimming, is obtained.

[Math. 23]

Λᵣ={vⱼ∈Qᵣ|∃vᵢ∉Qᵣ⁻,(vᵢ,vⱼ)∈Eᵣ} (23)

By using the control target identification assisting screen components and the screen identification assisting screen components necessary for satisfying the first and second trimming conditions obtained by the methods described above, the trimming unit 132 performs trimming by deleting the remaining screen components such that the screen components of the control target, the control target identification assisting screen components, the screen identification assisting screen components, and the ancestors thereof remain.

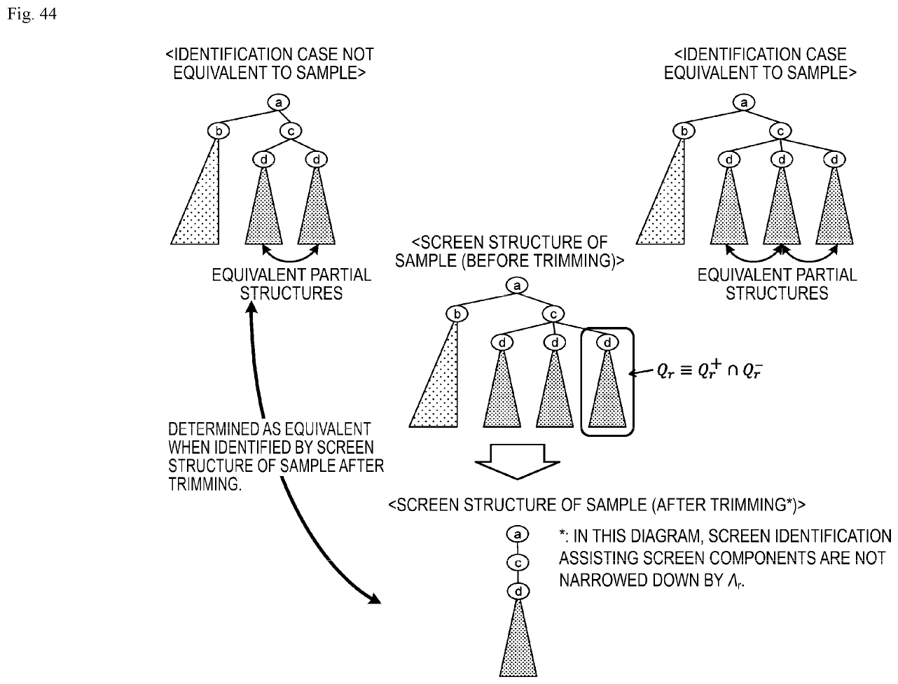

Note that FIG. 44 is a diagram illustrating an example in which equivalence of screen structures changes due to the number of equivalent partial structures. In the case of the non-equivalent identification case illustrated in FIG. 44, when identified by the screen structure of the sample after trimming, in which other screen components are trimmed, leaving the screen component v included in the set Qᵣ and the ancestors thereof, the identification case is determined as equivalent.

Thus, as illustrated in FIG. 44, in a case where the screen structure changes depending on the number of repeating units and the equivalence changes accordingly, the identification result changes before and after the trimming by this method, so that the trimming cannot be performed. For this reason, only in a case where the identification result does not change before and after trimming by using the identification cases accumulated in the identification case storage unit 126 (step S97 in FIG. 31: No), the trimming unit 132 saves the trimming result in the identification information storage unit 123 (step S98 in FIG. 31) and uses the trimming result in the subsequent identification processes.

In the screen structure of the sample after trimming, there will be no screen components that are allowed not to be associated with the screen structure elements in the screen structure of the processing target, other than those left only because they are the screen components of the control target or the control target identification assisting screen components, or the ancestors thereof. In particular, in a case where ˜θ=1, there is no screen component that is allowed not to be associated with the screen structure elements in the screen structure of the processing target.

Thus, in the subsequent identification processes performed by using the screen structures after trimming, assuming that the set of screen components that consists of the screen component v and the ancestors thereof included in the set Λᵣ is Λ*ᵣ, the screen structure comparison unit 1514 performs the process of determining the equivalence in step S42 by using Relationships (26) and (27), instead of the process of determining the equivalence of the screen structures by using Relationships (24) and (25) (which is the same relationship as Relationship (5) in FIG. 16) (see FIG. 16).

$$[ Math . 24 ]$$

$$\frac{\vert Def ( \hat{f} ) \vert}{\vert {V}_{r} \vert} < θ \qquad ( 24 )$$

$$[ Math . 25 ]$$

$$\frac{\vert Def ( \hat{f} ) \vert}{\vert {V}_{r} \vert} ≧ θ \qquad ( 25 )$$

$$[ Math . 26 ]$$

$$\frac{\vert Def ( \hat{f} ) ⋂ {Λ}_{r}^{*} \vert}{\vert {Λ}_{r}^{*} \vert} < 1 \qquad ( 26 )$$

$$[ Math . 27 ]$$

$$\frac{\vert Def ( \hat{f} ) ⋂ {Λ}_{r}^{*} \vert}{\vert {Λ}_{r}^{*} \vert} = 1 \qquad ( 27 )$$

### 13. Effects of the Embodiment

As described above, the identification apparatus 10 according to the embodiment determines the equivalence of the screens and the screen components upon considering whether a screen component in the screen structure of the sample and a screen component in the screen structure of the processing target that have the same attribute values and can be equivalent have similar relationships to other screen components in the respective screen structures.

Specifically, the identification apparatus 10 compares the screen structures of the sample and the processing target with each other, and obtains common partial structures such that the evaluation of the association method is best based on the number of screen components associated with the screen components of the processing target among the screen components of the control target, the number of screen components associated with the screen components of the processing target among all of the screen components of the sample, and the like. In addition, the identification apparatus 10 determines the equivalence of the screens and the screen components by comparing the ratio of these numbers to the number of screen components of the control target, the number of screen components of the sample, and the like, with a predetermined threshold value.

In addition, the identification apparatus 10 uses the number of screen components of the processing target that are subject to the operations by the operator, which are screen components associated with the screen components of the control target, for the evaluation of the association method. In this way, in a plurality of equivalent repeating units of the repeating structure, the identification apparatus 10 associates the screen components included in the same repeating unit as the screen components of the processing target that are subject to the operations by the operator with the screen components of the control target.

Alternatively, the identification apparatus 10 deletes a part of the screen components of the processing target associated with the screen components of the sample, and repeatedly obtains the association method that gives the best evaluation again, so that it is possible to obtain all of the screen components of the processing target that are equivalent to the screen components of the control target included in the repeating structure.

In addition, the identification apparatus 10 specifies comparison rules only for the screens, the screen components, or the attributes thereof that need to be individually adjusted for how to determine the match or the mismatch, to control the determination of the equivalence according to the screens of the application target or the applications.

As a result, the identification apparatus 10 can identify the screen and the screen components in a case where the attribute values of the screen components and the screen structure vary depending on the displayed matter even with the equivalent screen.

In addition, the identification apparatus 10 can identify the screen and the screen components even in a case where the invariant attributes are limited to the types of the screen components or the like in the information of the screen components that can be acquired, and each screen component cannot be uniquely identified even by using the attributes of the screen components of the control target and the ancestors thereof or combinations of a plurality of attributes.

In addition, the identification apparatus 10 can identify the screen and the screen components even in a case where the arrangement of the screen components on the two-dimensional plane changes depending on the size of the screen or the amount of display contents.

In addition, in the identification apparatus 10, it is not always necessary for a person to create the determination conditions of the equivalence of the screen components of the control target for each screen or screen component, so that the burden on the creator can be reduced.

The identification apparatus 10 trims the screen structure of the sample such that the control target screen components and the ancestors and the neighbors thereof remain. For this reason, according to the identification apparatus 10, the number of screen components included in the screen structure of the sample can be reduced, and the amount of calculation required for identification can be reduced.

The identification apparatus 10 compares the control target screen components with the ancestors, the descendants, or the neighbors of each of the screen components similar to the control target screen components in the screen structure of the sample, and obtains common portions and non-common portions. As a result, the identification apparatus 10 can specify portions that do not affect the identification results for the screen structure of the sample, and appropriately trim the portions.

In addition, the identification apparatus 10 obtains common portions and non-common portions by comparison with the screen structures of equivalent or non-equivalent screen data accumulated in the screen data identification case accumulation unit. As a result, the identification apparatus 10 can specify portions that do not affect the identification results for the screen structure of the sample, and appropriately trim the portions.

### System Configuration in Embodiment

Each component of the identification apparatus 10 and the assistance apparatus 20 illustrated in FIG. 5 is a functional concept and may not necessarily be physically configured as in the drawing. That is, the specific forms of distribution and integration of the functions of the identification apparatus 10 and the assistance apparatus 20 are not limited to the illustrated forms, and all or part of the forms can be configured by being functionally or physically distributed or integrated in any unit, depending on various loads, usage conditions, and the like.

All or any part of each process performed by the identification apparatus 10 and the assistance apparatus 20 may be implemented by a CPU and a program that is analyzed and executed by the CPU. Each process performed by the identification apparatus 10 and the assistance apparatus 20 may be implemented as hardware based on a wired logic.

All or some of the processes described as being automatically performed among the processes described in the embodiment may be manually performed. Alternatively, all or some of the processes described as being manually performed can be automatically performed using a publicly known method. In addition, the processing procedures, control procedures, specific names, and information including various types of data and parameters described and illustrated above can be appropriately changed unless otherwise specified.

Program

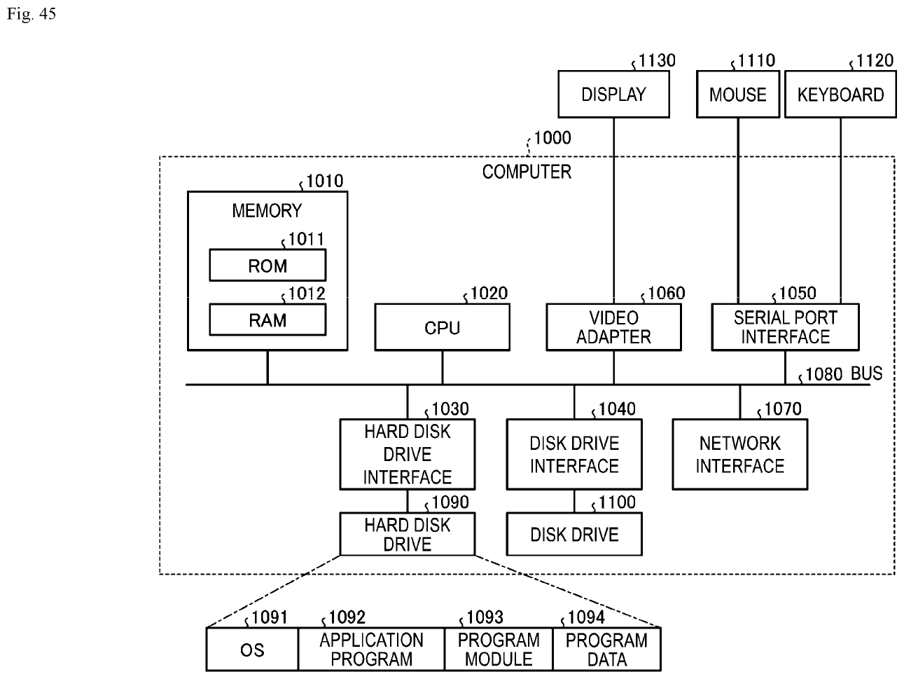

FIG. 45 is a diagram illustrating an example of a computer that executes programs to implement the identification apparatus 10 and the assistance apparatus 20. A computer 1000 includes, for example, a memory 1010 and a CPU 1020. The computer 1000 also includes a hard disk drive interface 1030, a disk drive interface 1040, a serial port interface 1050, a video adapter 1060, and a network interface 1070. Each of these units is connected by a bus 1080.

The memory 1010 includes a ROM 1011 and a RAM 1012. The ROM 1011 stores, for example, a boot program such as a Basic Input Output System (BIOS). The hard disk drive interface 1030 is connected to a hard disk drive 1090. The disk drive interface 1040 is connected to a disk drive 1100. For example, a removable storage medium such as a magnetic disk or an optical disk is inserted into the disk drive 1100. The serial port interface 1050 is connected to, for example, a mouse 1110 and a keyboard 1120. The video adapter 1060 is connected to, for example, a display 1130.

The hard disk drive 1090 stores, for example, an OS 1091, an application program 1092, a program module 1093, and program data 1094. That is, a program defining each process of the identification apparatus 10 and the assistance apparatus 20 is implemented as a program module 1093 in which a code executable by the computer 1000 is written. The program module 1093 is stored in, for example, the hard disk drive 1090. For example, the program module 1093 for executing the similar processes as those performed by the functional configurations in the identification apparatus 10 and the assistance apparatus 20 is stored in the hard disk drive 1090. Note that the hard disk drive 1090 may be replaced with a Solid State Drive (SSD).

Configuration data to be used in the processes of the embodiments described above is stored as the program data 1094 in, for example, the memory 1010 or the hard disk drive 1090. In addition, the CPU 1020 reads the program module 1093 and the program data 1094 stored in the memory 1010 or the hard disk drive 1090 into the RAM 1012 and executes them, as necessary.

Note that the program module 1093 and the program data 1094 are not limited to being stored in the hard disk drive 1090 and, for example, may be stored in a detachable storage medium and read by the CPU 1020 via the disk drive 1100 or the like. Alternatively, the program module 1093 and the program data 1094 may be stored in other computers connected via a network (a Local Area Network (LAN), a Wide Area Network (WAN), or the like). In addition, the program module 1093 and the program data 1094 may be read by the CPU 1020 from another computer via the network interface 1070.

Although the embodiment to which the invention made by the inventors is applied has been described above, the present invention is not limited by the description and the drawings which constitute a part of the disclosure of the present invention according to the present embodiment. That is, other embodiments, examples, operation technologies, and the like made by those skilled in the art based on the present embodiment are all included in the scope of the present invention.

### REFERENCE SIGNS LIST

1 Identification system
10 Identification apparatus
11 Communication unit
12 Storage unit
13 Control unit
20 Assistance apparatus
21 Identification process calling unit
22 Screen component control unit
121 Processing target screen data storage unit
122 Identification result storage unit
123 Identification information storage unit
124 Screen attribute comparison rule storage unit
125 Element attribute comparison rule storage unit
126 Identification case storage unit
131 Identification unit
132 Trimming unit
1311 Processing target reception unit
1312 Sample selection unit
1313 Screen attribute comparison unit
1314 Screen structure comparison unit
1315 Identification result saving unit

1. An identification apparatus comprising
a screen structure comparison unit, including one or more processors, configured to determine equivalence of screen components between sample screen data and processing target screen data based on whether a screen component in a screen structure of the sample screen data and a screen component in a screen structure of the processing target screen data have similar relationships to other screen components in each of the screen structure of the sample screen data and the screen structure of the processing target screen data.

2. The identification apparatus according to claim 1, wherein
the screen structure comparison unit is configured to extract elements being common portions in such a manner that an evaluation of an association method of screen components based on the number of screen components corresponding to screen components in the screen structure of the processing target screen data among all screen components of the screen structure of the sample screen data is best, compare a ratio of the screen components corresponding to the screen components of the processing target screen data among all of the screen components of the sample screen data with a predetermined threshold value, and determine the equivalence of the screen components.

3. The identification apparatus according to claim 2, wherein
the screen structure comparison unit is configured to use the number of screen components associated with screen components in the screen structure of the processing target screen data among screen components of control target extracted from the screen structure of the sample screen data, or the number of screen components of the processing target screen data that are subject to operation, the screen components being associated with the screen components of the control target, for the evaluation of the association method or a determination of the equivalence.

4. The identification apparatus according to claim 2, wherein
the screen structure comparison unit is configured to repeat processing of deleting a part of the screen components of the processing target screen data associated with the screen components of the screen structure of the sample screen data and obtaining the association method that gives best evaluation.

5. The identification apparatus according to claim 1, further comprising
a removing unit, including one or more processors, configured to remove screen components not corresponding to any of the screen components of the control target, ancestors of the screen components of the control target, or screen components of neighbors, from the screen structure of the sample screen data.

6. The identification apparatus according to claim 1, further comprising:
an identification information storage unit, including one or more processors, configured to store the sample screen data;
an identification case storage, including one or more processors, configured to store a determination result for the equivalence between the screen structure of the sample screen data and the screen structure of the processing target screen data by the screen structure comparison unit; and
a removing unit, including one or more processors, configured to remove screen components not affecting an identification result from the screen structure of the sample screen data by comparison with screen structures of screen data equivalent to or non-equivalent to the screen structure of the sample screen data by referring to the identification case storage unit.

7. An identification method performed by an identification apparatus, the identification method comprising
determining equivalence of screen components between sample screen data and processing target screen data based on whether a screen component in a screen structure of the sample screen data and a screen component in a screen structure of the processing target screen data have similar relationships to other screen components in each of the screen structure of the sample screen data and the screen structure of the processing target screen data.

8. A non-transitory computer readable medium storing an identification program for causing a computer to perform operations comprising:
determining equivalence of screen components between sample screen data and processing target screen data based on whether a screen component in a screen structure of the sample screen data and a screen component in a screen structure of the processing target screen data have similar relationships to other screen components in each of the screen structure of the sample screen data and the screen structure of the processing target screen data.

9. The non-transitory computer readable medium according to claim 8, wherein the operations further comprise:
extracting elements being common portions in such a manner that an evaluation of an association method of screen components based on the number of screen components corresponding to screen components in the screen structure of the processing target screen data among all screen components of the screen structure of the sample screen data is best, comparing a ratio of the screen components corresponding to the screen components of the processing target screen data among all of the screen components of the sample screen data with a predetermined threshold value, and determining the equivalence of the screen components.

10. The non-transitory computer readable medium according to claim 9, wherein the operations further comprise:
using the number of screen components associated with screen components in the screen structure of the processing target screen data among screen components of control target extracted from the screen structure of the sample screen data, or the number of screen components of the processing target screen data that are subject to operation, the screen components being associated with the screen components of the control target, for the evaluation of the association method or a determination of the equivalence.

11. The non-transitory computer readable medium according to claim 9, wherein the operations further comprise:
repeating processing of deleting a part of the screen components of the processing target screen data associated with the screen components of the screen structure of the sample screen data and obtaining the association method that gives best evaluation.

12. The non-transitory computer readable medium according to claim 8, wherein the operations further comprise:
removing screen components not corresponding to any of the screen components of the control target, ancestors of the screen components of the control target, or screen components of neighbors, from the screen structure of the sample screen data.

13. The non-transitory computer readable medium according to claim 8, wherein the operations further comprise:
storing the sample screen data;
storing a determination result for the equivalence between the screen structure of the sample screen data and the screen structure of the processing target screen data by the screen structure comparison unit; and
removing screen components not affecting an identification result from the screen structure of the sample screen data by comparison with screen structures of screen data equivalent to or non-equivalent to the screen structure of the sample screen data by referring to the identification case storage unit.

14. The identification method according to claim 7, further comprising:
extracting elements being common portions in such a manner that an evaluation of an association method of screen components based on the number of screen components corresponding to screen components in the screen structure of the processing target screen data among all screen components of the screen structure of the sample screen data is best, comparing a ratio of the screen components corresponding to the screen components of the processing target screen data among all of the screen components of the sample screen data with a predetermined threshold value, and determining the equivalence of the screen components.

15. The identification method according to claim 14, further comprising:
using the number of screen components associated with screen components in the screen structure of the processing target screen data among screen components of control target extracted from the screen structure of the sample screen data, or the number of screen components of the processing target screen data that are subject to operation, the screen components being associated with the screen components of the control target, for the evaluation of the association method or a determination of the equivalence.

16. The identification method according to claim 14, further comprising:
repeating processing of deleting a part of the screen components of the processing target screen data associated with the screen components of the screen structure of the sample screen data and obtaining the association method that gives best evaluation.

17. The identification method according to claim 7, further comprising:
removing screen components not corresponding to any of the screen components of the control target, ancestors of the screen components of the control target, or screen components of neighbors, from the screen structure of the sample screen data.

18. The identification method according to claim 7, further comprising:
storing the sample screen data;
storing a determination result for the equivalence between the screen structure of the sample screen data and the screen structure of the processing target screen data by the screen structure comparison unit; and
removing screen components not affecting an identification result from the screen structure of the sample screen data by comparison with screen structures of screen data equivalent to or non-equivalent to the screen structure of the sample screen data by referring to the identification case storage unit.
